(19) United States
(12) Patent Application Publication
(10) Pub. No.: US 2016/0337101 A1
(43) Pub. Date: Nov. 17, 2016

(54) SIGNAL TRANSMISSION METHOD AND SIGNAL TRANSMISSION APPARATUS

(71) Applicant: CHINA ACADEMY OF TELECOMMUNICATIONS TECHNOLOGY, Beijing (CN)

(72) Inventors: Xuejuan GAO, Beijing (CN); Yaman LIN, Beijing (CN); Zukang SHEN, Beijing (CN)

(21) Appl. No.: 15/111,801

(22) PCT Filed: Jan. 16, 2015
(86) PCT No.: PCT/CN2015/070886

§ 371 Date: Jul. 14, 2016

(30) Foreign Application Priority Data
Jan. 17, 2014 (CN) 201410023237.1

(51) Int. Cl. H04L 5/00; H04W 24/10; H04W 56/00; H04W 72/04; H04L 5/14

(52) U.S. Cl. CPC H04L 5/0048; H04L 5/0082; H04W 72/0446; H04L 5/14; H04L 5/0007; H04W 56/001; H04W 24/10

(57) ABSTRACT

The present disclosure provides a signal transmission method and a signal transmission apparatus. The signal transmission method includes steps of receiving, by a UE, a signal on a carrier or cell which uses a predetermined spectrum resource, and determining whether or not the received signal belongs to a serving carrier or serving cell of the UE; and in the case that the received signal belongs to the serving carrier or serving cell of the UE, performing measurement and/or data transmission by the UE in accordance with the received signal and/or a subsequently-received signal.

### CROSS-REFERENCE TO RELATED APPLICATION

The present application claims a priority of the Chinese Patent Application No. 201410023237.1 filed on Jan. 17, 2014 and entitled “signal transmission method and signal transmission apparatus”, which is incorporated herein by reference its entirety.

### TECHNICAL FIELD

The present disclosure relates to the field of communication technology, in particular to a signal transmission method and a signal transmission apparatus.

### BACKGROUND

Along with the increase of the mobile data service volume, spectrum resources have become more and more scarce, and it is probably impossible to meet the service requirement in the case that merely the licensed spectrum resources are used for network deployment and service transmission. Hence, a Long-Term Evolution (LTE) system may perform the network deployment and service transmission over an unlicensed LTE (U-LTE or LTE-U), so as to improve the user experience and expand the network coverage.

(1) Synchronization Signal and Reference Signal in the LTE System

The reference signal (RS) in the LTE system may include a cell-specific reference signal (CRS), a user equipment (UE)-specific reference signal (UE-RS, also called as demodulation reference signal (DMRS)), a channel state information reference signal (CSI-RS), a positioning reference signal (PRS), etc. The CRS may be used for demodulation and measurement, e.g., measuring reference signal received power (RSRP) or reference signal received quality (RSRQ), the DMRS is mainly used for the demodulation of the downlink transmission dedicated for the UE, the CSI-RS is used for measuring channel state information, and the PRS is used for the positioning measurement.

In addition, the synchronization signal is mainly used for downlink synchronization, so as to enable the UE to achieve the timing of a radio frame and a subframe of the LTE system to be accessed by the UE. The synchronization signal may include a primary synchronization signal (PSS) and a secondary synchronization signal (SSS). To be specific, the PSS includes three sequences, and it is transmitted every 5 ms. The sequences transmitted within two adjacent half-frames are identical to each other, so as to acquire a duration of 5 ms. The SSS includes two binary sequences interleaved and concatenated with each other, and each binary sequence has a length of 31. The SSS is scrambled with a scrambling sequence indicated by the PSS, and interleaving modes are different from each other within the two adjacent half-frames, so as to acquire a duration of 10 ms, i.e., to determine a timing start position of the radio frame. The synchronization signal is further used to acquire a cell identifier (ID) by the UE. The cell ID is a unique identifier of a cell, and 504 cell IDs in the LTE system may be divided into 168 groups, each group having three cell IDs. For the cell ID, N_{ID}^{cell}=3N_{ID}⁽¹⁾+N_{ID}⁽²⁾, where N_{ID}⁽¹⁾ is acquired by detecting the SSS and it has a value of 0 to 167, and N_{ID}⁽²⁾ is acquired by detecting the PSS and it has a value of 0 to 2.

The PSS and the SSS are mapped onto the middle 72 sub-carriers in each carrier frequency domain and then transmitted, and in the LTE system, 6 resource blocks (RBs) are occupied by them. For a Frequency Division Duplex (FDD) system, as shown in FIG. 1a, the PSS and the SSS are transmitted over the last Orthogonal Frequency Division Multiplexing (OFDM) symbol and the second last OFDM symbol in a first timeslot of each of subframe 0 and subframe 5 respectively. For a Time Division Duplex (TDD) system, as shown in FIG. 1b, the PSS is transmitted over the third OFDM symbol in subframes 1 and 6, and in the case that the subframe 1 or 6 is a particular subframe, it is transmitted over the third OFDM symbol in a Downlink Pilot Timeslot (DwPTS). The SSS is transmitted over the last OFDM symbol in second timeslots of subframes 0 and 5.

(2) Unlicensed Spectrum Resources

Conventional spectrum resources may include licensed spectrum resources and unlicensed spectrum resources. The licensed spectrum resources are dedicated spectrum resources, and their interferences are substantially predictable. The unlicensed spectrum resources are not specified for a certain application system, i.e., they may be shared by various systems, e.g., LTE and WiFi systems, in a preemptive manner. FIG. 2 shows a resource preemption mode of the WiFi system for the unlicensed spectrum resources. In FIG. 2, the resource contention occurs for several systems (base stations A-E) within their respective contention windows. The systems determine whether or not a current spectrum resource is busy by monitoring a Distributed Inter-Frame Space (DIFS) region, and in the case that the DIFS region with a particular length may be detected, it means the current spectrum resource is free and may be used by the systems. In addition, a backoff duration may be maintained by each base station, and the backoff duration for each base station is determined by a fixed value and a random number (for each of the base stations A-E, its backoff duration includes a remaining backoff value), so as to provide different base station with different backoff durations, thereby to prevent a resource conflict caused when the free resource within an identical duration is detected by the base stations. In the case that the backoff duration for one base station is ended and the free spectrum resource has been detected, the data may be transmitted over the free spectrum resource. Moreover, for the sake of fairness, it is stipulated that each base station cannot occupy the spectrum resource for a long period of time, and a predetermined duration expires or a volume of the transmitted data reaches an upper limit, the base station needs to release the spectrum resource for the other WiFi or LTE systems.

Based on the above-mentioned mechanism, in the case that the data is not transmitted by the LTE system over parts of the OFDM symbols in a subframe, e.g., the reference signals rather than the service data is transmitted in a current subframe, the reference signals may merely be transmitted over a part of the bandwidth and/or parts of the OFDM symbols. At this time, the transmission energy is relatively small, so the other LTE or WiFi systems may determine that these OFDM symbols in the subframe are free, and then start to occupy and use the unlicensed spectrum resource, resulting in interferences to the current LTE system and mutual interferences among the systems. In addition, due to the spectrum resource preemption, in the case that the current LTE UE operates at the unlicensed spectrum resource as a secondary carrier, it cannot determine whether or not a signal is received from an LTE base station which serves the UE before a particular identification step.

Currently, there is no scheme about how the LTE system operates at the unlicensed spectrum resource. Especially for the LTE system where different LTE base stations may preempt the unlicensed spectrum resource to transmit the signal, the current UE cannot determine whether or not a received signal comes from the LTE base station which serves the UE, so the UE may receive an erroneous signal and thereby the system performance may be degraded. Hence, there is an urgent need to find an effective scheme to overcome the above-mentioned drawbacks.

### SUMMARY

An object of the present disclosure is to provide a signal transmission method and a signal transmission apparatus, so as to enable a UE to perform measurement and/or receive data in the case that a signal is currently received from a serving base station or serving cell, thereby to prevent the system performance from being degraded.

In one aspect, the present disclosure provides in some embodiments a signal transmission method, including steps of: receiving, by a UE, a signal on a carrier or cell which uses a predetermined spectrum resource, and determining whether or not the received signal belongs to a serving carrier or serving cell of the UE; and in the case that the received signal belongs to the serving carrier or serving cell of the UE, performing measurement and/or data transmission by the UE in accordance with the received signal and/or a subsequently-received signal.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

Alternatively, the step of performing the measurement and/or data transmission by the UE in accordance with the received signal and/or the subsequently-received signal includes at least one of: performing the measurement by the UE in accordance with a received reference signal for measurement; receiving by the UE a further reference signal for measurement, and performing the measurement in accordance with the received further reference signal for measurement; performing the data transmission by the UE in accordance with received scheduling signaling; and receiving by the UE further scheduling signaling, and performing the data transmission in accordance with the received further scheduling signaling.

Alternatively, the reference signal for measurement is transmitted on an OFDM symbol on which synchronization signals are currently transmitted and using all frequency domain resources other than the frequency domain resources occupied by the synchronization signals, or the reference signal for measurement is transmitted on an OFDM symbol on which synchronization signals are currently transmitted and using parts of the frequency domain resources other than the frequency domain resources occupied by the synchronization signals, or the reference signal for measurement is transmitted on an OFDM symbol adjacent to, or separated by a fixed time domain interval from, the OFDM symbol on which synchronization signals are currently transmitted and the reference signal for measurement and at least one synchronization signal in the synchronization signals are transmitted within an identical subframe, or the reference signal for measurement is the synchronization signal.

Alternatively, sequences of the reference signal for measurement are generated at least in association with an ID of a carrier or cell on which the reference signal is currently transmitted, or in the case that the reference signal for measurement is used for measuring RSRP and/or CSI, sequences of the reference signal for measurement are generated at least in association with an ID of a carrier or cell on which the reference signal is currently transmitted, or sequences of the reference signal for measurement are sequences of a UE-specific or cell-specific measurement reference signal and pre-configured by configuration signaling, or in the case that the reference signal for measurement is used for measuring CSI, sequences of the reference signal for measurement is sequences of a UE-specific or cell-specific measurement reference signal and pre-configured through configuration signaling.

Alternatively, the reference signal for measurement is used for at least one of RSRP measurement, RSRQ measurement, positioning measurement, tracking measurement and CSI measurement.

Alternatively, the step of determining by the UE whether or not the received signal belongs to the serving carrier or serving cell includes at least one of: detecting, by the UE, a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and detecting, by the UE, dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

Alternatively, the step of detecting, by the UE, the synchronization signal corresponding to the ID of the carrier or cell in accordance with the ID of the carrier or cell pre-configured through the configuration signaling includes: detecting, by the UE, the synchronization signal corresponding to the ID of the carrier or cell in each subframe or a predetermined subframe in which the synchronization signal is to be transmitted in accordance with the ID of the carrier or cell pre-configured through the configuration signaling; and/or the step of detecting, by the UE, the dedicated sequences pre-configured through the configuration signaling includes: detecting, by the UE, the dedicated sequences in each subframe or a predetermined subframe, the predetermined subframe being a particular subframe pre-configured through the configuration signaling, or a subframe determined in accordance with a detection period, or the detection period and a subframe offset value, pre-configured through the configuration signaling.

Alternatively, the dedicated sequences are sequences of a particular reference signal for measurement pre-configured for the UE through the configuration signaling, and/or the terminal detects the dedicated sequences in an energy detection manner.

Alternatively, the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or a subframe or OFDM symbol for transmitting the synchronization signal on the carrier or cell which uses the predetermined spectrum resource is acquired in advance in accordance with the configuration signaling; or an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol and the offset value.

Alternatively, the synchronization signal includes a PSS and/or an SSS.

Alternatively, a bandwidth of the carrier or cell which uses the predetermined spectrum resource is notified in advance through the configuration signaling, or in the case that the bandwidth of the carrier or cell which uses the predetermined spectrum resource is unknown, the UE receives the reference signal for measurement and performs the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the predetermined spectrum resource is an unlicensed spectrum resource.

Alternatively, the carrier or cell is a secondary carrier or secondary cell pre-configured for the UE through the configuration signaling.

Alternatively, the carrier or cell which uses the predetermined spectrum resource is a secondary carrier or secondary cell pre-configured for the UE through the configuration signaling.

In yet another aspect, the present disclosure provides in some embodiments a signal transmission method, including a step of transmitting, by a base station, a signal on a carrier or cell which uses a predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, the judge signal is further used for measurement.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

Alternatively, the signal transmission method further includes: determining, by the base station, whether or not a current channel resource on the carrier or cell which uses the predetermined spectrum resource is free; in the case that the current channel resource is free, transmitting, by the base station, the signal on the carrier or cell which uses the predetermined spectrum resource; and in the case that the current channel resource is busy, prohibiting, by the base station, the transmission of the signal on the carrier or cell which uses the predetermined spectrum resource, or transmitting, by the base station, the signal on the carrier or cell which uses the predetermined spectrum resource after a predetermined time period. The predetermined time period has a length of a pre-defined fixed value, or the length of the predetermined time period is notified to the UE in advance through signaling.

Alternatively, the judge signal is a synchronization signal corresponding to an ID Of the carrier or cell which uses the predetermined spectrum resource, and the base station transmits the synchronization signal and the reference signal for measurement and/or the data signal, or transmits the synchronization signal, or transmits the synchronization signal and the data signal, on the carrier or cell which uses the predetermined spectrum resource. The base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling. Alternatively, the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling. Alternatively, the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling.

Alternatively, the judge signal is dedicated sequences corresponding to the carrier or cell which uses the predetermined spectrum resources or dedicated sequences of the UE, and the base station transmits the dedicated sequences and a reference signal for measurement and/or a data signal, or transmits the dedicated sequences, or transmits the dedicated sequences and the data signal, on the carrier or cell which uses the predetermined spectrum resources. The base station transmits the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling. Alternatively, the base station transmits the dedicated sequences in each subframe or a pre-defined subframe on the carrier or cell which uses the predetermined spectrum resource, the dedicated sequences are pre-configured by the base station for the UE through the configuration signaling, and the pre-defined subframe is a particular subframe pre-configured through the configuration signaling or a subframe determined in accordance with a detection period, or the detection period and a subframe offset value, pre-configured through the configuration signaling. Alternatively, the base station transmits the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

Alternatively, the reference signal for measurement is transmitted on an OFDM symbol on which synchronization signals are currently transmitted and using all frequency domain resources other than the frequency domain resources occupied by the synchronization signals, or the reference signal for measurement is transmitted on an OFDM symbol on which synchronization signals are currently transmitted and using parts of the frequency domain resources other than the frequency domain resources occupied by the synchronization signals, or the reference signal for measurement is transmitted on an OFDM symbol adjacent to, or separated by a fixed time domain interval from, the OFDM symbol on which synchronization signals are currently transmitted and the reference signal for measurement and at least one synchronization signal in the synchronization signals are transmitted within an identical subframe, or the reference signal for measurement is the synchronization signal.

Alternatively, sequences of the reference signal for measurement are generated at least in association with an ID of a carrier or cell on which the reference signal is currently transmitted, or in the case that the reference signal for measurement is used for measuring RSRP and/or CSI, sequences of the reference signal for measurement are generated at least in association with an ID of a carrier or cell on which the reference signal is currently transmitted, or sequences of the reference signal for measurement are sequences of a UE-specific or cell-specific measurement reference signal and pre-configured by configuration signaling, or in the case that the reference signal for measurement is used for measuring CSI, sequences of the reference signal for measurement is sequences of a UE-specific measurement reference signal and pre-configured through configuration signaling.

Alternatively, the reference signal for measurement is used for at least one of RSRP measurement, RSRQ measurement, positioning measurement, tracking measurement and CSI measurement.

Alternatively, the dedicated sequences are sequences of a particular reference signal for measurement pre-configured for the UE through the configuration signaling.

Alternatively, the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling; or the subframe or OFDM symbol for transmitting the synchronization signal on the carrier or cell which uses the predetermined spectrum resource is determined in accordance with a pre-defined position of the subframe or OFDM symbol and an offset value for transmitting the synchronization signal on the carrier or cell which uses the predetermined spectrum resource. The offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling.

Alternatively, the synchronization signal includes a PSS and/or an SSS.

Alternatively, a bandwidth of the carrier or cell which uses the predetermined spectrum resource is notified by the base station to the UE in advance through signaling; or the bandwidth of the carrier or cell which uses the predetermined spectrum resource is notified by the base station to a master base station in advance, and notified by the master base station to the UE in advance through signaling; or the bandwidth of the carrier or cell which uses the predetermined spectrum resource is notified by the master base station to the UE in advance through configuration signaling. In the case that the bandwidth of the carrier or cell which uses the predetermined spectrum resource is not notified by the base station or the master base station to the UE in advance through the configuration signaling, the base station determines that the UE receives the reference signal for measurement and perform the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the predetermined spectrum resource is an unlicensed spectrum resource.

Alternatively, the carrier or cell is a secondary carrier or secondary cell pre-configured for the UE through the configuration signaling.

In yet another aspect, the present disclosure provides in some embodiments a signal transmission apparatus, including: a reception module configured to receive a signal; and a determination module configured to, in the case that the reception module receives the signal on a carrier or cell which uses a predetermined spectrum resource, determine whether or not the received signal belongs to a serving carrier or serving cell of a UE. The reception module is further configured to, in the case that the received signal belongs to the serving carrier or serving cell of the UE, perform measurement and/or data transmission in accordance with the received signal and/or a subsequently-received signal.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

Alternatively, the reception module is further configured to perform at least one of the following processings: performing the measurement by the UE in accordance with a received reference signal for measurement; receiving a further reference signal for measurement, and performing the measurement in accordance with the received further reference signal for measurement; performing the data transmission in accordance with received scheduling signaling; and receiving further scheduling signaling, and performing the data transmission in accordance with the received further scheduling signaling.

Alternatively, the reception module is configured to receive the reference signal for measurement on an OFDM symbol on which synchronization signals are currently transmitted and using all frequency domain resources other than the frequency domain resources occupied by the synchronization signals, or receive the reference signal for measurement on an OFDM symbol on which synchronization signals are currently transmitted and using parts of the frequency domain resources other than the frequency domain resources occupied by the synchronization signals, or receive the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or receive the synchronization signal as the reference signal for measurement.

Alternatively, the reception module is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific or cell-specific measurement reference signal and pre-configured through configuration signaling as sequences of the reference signal for measurement.

Alternatively, the reception module is further configured to perform at least one of RSRP measurement, RSRQ measurement, positioning measurement, tracking measurement and CSI measurement using the reference signal for measurement.

Alternatively, the determination module is further configured to perform at least one of the following processings: detecting a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and detecting dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

Alternatively, in the case that the determination module detects the synchronization signal corresponding to the ID of the carrier or cell in accordance with the ID of the carrier or cell pre-configured through the configuration signaling, the determination module is further configured to detect the synchronization signal corresponding to the ID of the carrier or cell in each subframe or a predetermined subframe in which the synchronization signal is to be transmitted in accordance with the ID of the carrier or cell pre-configured through the configuration signaling. In the case that the determination module detects the dedicated sequences pre-configured through the configuration signaling, the determination module is further configured to detect the dedicated sequences in each subframe or a predetermined subframe, and the predetermined subframe is a particular subframe pre-configured through the configuration signaling, or a subframe determined in accordance with a detection period, or the detection period and a subframe offset value, pre-configured through the configuration signaling.

Alternatively, the determination module is further configured to determine sequences of a particular reference signal for measurement pre-configured for the UE through the configuration signaling as the dedicated sequences, and/or detect the dedicated sequences in an energy detection manner.

Alternatively, the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or a subframe or OFDM symbol for transmitting the synchronization signal on the carrier or cell which uses the predetermined spectrum resource is acquired in advance in accordance with the configuration signaling; or an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol and the offset value.

Alternatively, the synchronization signal includes a PSS and/or an SSS.

Alternatively, the reception module is further configured to determine that a bandwidth of the carrier or cell which uses the predetermined spectrum resource is notified in advance through the configuration signaling, or in the case that the bandwidth of the carrier or cell which uses the predetermined spectrum resource is unknown, receive the reference signal for measurement and perform the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the reception module or the determination module is further configured to determine that the predetermined spectrum resource is an unlicensed spectrum resource.

Alternatively, the reception module is further configured to determine that the carrier or cell is a secondary carrier or secondary cell pre-configured for the UE through the configuration signaling.

Alternatively, the reception module is further configured to determine that the carrier or cell which uses the predetermined spectrum resource is a secondary carrier or secondary cell pre-configured for the UE through the configuration signaling.

In still yet another aspect, the present disclosure provides in some embodiments a signal transmission apparatus for a base station, including: a generation module configured to generate a signal; and a transmission module configured to transmit the signal on a carrier or cell which uses a predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, the judge signal is further used for measurement.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

Alternatively, the signal transmission apparatus further includes a judgment module configured to determine whether or not a current channel resource on the carrier or cell which uses the predetermined spectrum resource is free. In the case that the current channel resource is free, the transmission module is further configured to transmit the signal on the carrier or cell which uses the predetermined spectrum resource, and in the case that the current channel resource is busy, the transmission module is further configured to prohibit the transmission of the signal on the carrier or cell which uses the predetermined spectrum resource, or transmit the signal on the carrier or cell which uses the predetermined spectrum resource after a predetermined time period. The predetermined time period has a length of a pre-defined fixed value, or the length of the predetermined time period is notified to the UE in advance through signaling.

Alternatively, in the case that the judge signal is a synchronization signal corresponding to an ID of the carrier or cell which uses the predetermined spectrum resource, the transmission module is configured to transmit the synchronization signal and the reference signal for measurement and/or the data signal, or transmit the synchronization signal, or transmit the synchronization signal and the data signal, on the carrier or cell which uses the predetermined spectrum resource. The transmission module is configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling. Alternatively, the transmission module is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling. Alternatively, the transmission module is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling.

Alternatively, in the case that the judge signal is dedicated sequences corresponding to the carrier or cell which uses the predetermined spectrum resources or dedicated sequences of the UE, the transmission module is configured to transmit the dedicated sequences and a reference signal for measurement and/or a data signal, or transmit the dedicated sequences, or transmit the dedicated sequences and the data signal, on the carrier or cell which uses the predetermined spectrum resources. The transmission module is further configured to transmit the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transmission module is further configured to transmit the dedicated sequences in each subframe or a pre-defined subframe on the carrier or cell which uses the predetermined spectrum resource, the dedicated sequences are pre-configured by the base station for the UE through the configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transmission module is further configured to transmit the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

Alternatively, the transmission module is further configured to transmit the reference signal for measurement on an OFDM symbol on which synchronization signals are currently transmitted and using all frequency domain resources other than the frequency domain resources occupied by the synchronization signals, or transmit the reference signal for measurement on an OFDM symbol on which synchronization signals are currently transmitted and using parts of the frequency domain resources other than the frequency domain resources occupied by the synchronization signals, or transmit the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or transmit the synchronization signal as the reference signal for measurement.

Alternatively, the generation module is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific or cell-specific measurement reference signal and pre-configured through configuration signaling as sequences of the reference signal for measurement.

Alternatively, the generation module is further configured to perform at least one of RSRP measurement, RSRQ measurement, positioning measurement, tracking measurement and CSI measurement using the reference signal for measurement.

Alternatively, the generation module is further configured to determine sequences of a particular reference signal for measurement pre-configured for the UE through the configuration signaling as the dedicated sequences.

Alternatively, the transmission module is further configured to determine that: the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling; or the subframe or OFDM symbol for transmitting the synchronization signal on the carrier or cell which uses the predetermined spectrum resource is determined in accordance with a pre-defined position of the subframe or OFDM symbol and an offset value for transmitting the synchronization signal on the carrier or cell which uses the predetermined spectrum resource. The offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling.

Alternatively, the synchronization signal includes a PSS and/or an SSS.

Alternatively, the transmission module is further configured to: notify a bandwidth of the carrier or cell which uses the predetermined spectrum resource to the UE in advance through signaling; or notify the bandwidth of the carrier or cell which uses the predetermined spectrum resource to a master base station in advance, so that the master base station notifies the bandwidth to the UE in advance through signaling; or in the case that the bandwidth of the carrier or cell which uses the predetermined spectrum resource is not notified by the base station or the master base station to the UE in advance through the configuration signaling, determine that the UE receives the reference signal for measurement and perform the measurement on a pre-defined bandwidth in the middle of the carrier or cell which uses the predetermined spectrum resource. The pre-defined bandwidth is of a value not less than 6 RBs, or a value not less than a minimum bandwidth defined in an LTE system.

Alternatively, the transmission module is further configured to determine the predetermined spectrum resource as an unlicensed spectrum resource, and/or determine a secondary carrier or secondary cell pre-configured for the UE through the configuration signaling as the serving carrier or serving cell.

In still yet another aspect, the present disclosure provides in some embodiments a signal transmission apparatus, including a transceiver, a processor and a memory. The transceiver is configured to receive and transmit a signal under the control of the processor. The processor is configured to read a program stored in a memory so as to, in the case that the signal is received by the transceiver on a carrier or cell which uses a predetermined spectrum resource, determine whether or not the received signal belongs to a serving carrier or serving cell of a UE. The transceiver is further configured to, in the case that the received signal belongs to the serving carrier or serving cell of the UE, perform measurement and/or data transmission in accordance with the received signal and/or a subsequently-received signal.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

Alternatively, the transceiver is configured to perform at least one of the following processings: performing the measurement in accordance with a received reference signal for measurement; receiving a further reference signal for measurement, and performing the measurement in accordance with the received further reference signal for measurement; performing the data in accordance with received scheduling signaling; and receiving further scheduling signaling, and performing the data transmission in accordance with the received further scheduling signaling.

Alternatively, the transceiver is further configured to receive the reference signal for measurement on an OFDM symbol on which synchronization signals are currently transmitted and using all frequency domain resources other than the frequency domain resources occupied by the synchronization signals, or receive the reference signal for measurement an OFDM symbol on which synchronization signals are currently transmitted and using parts of the frequency domain resources other than the frequency domain resources occupied by the synchronization signals, or receive the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or receive the synchronization signal as the reference signal for measurement.

Alternatively, the transceiver is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific or cell-specific measurement reference signal and pre-configured through configuration signaling as sequences of the reference signal for measurement.

Alternatively, the transceiver is further configured to perform at least one of RSRP measurement, RSRQ measurement, positioning measurement, tracking measurement and CSI measurement using the reference signal for measurement.

Alternatively, the processor is configured to perform at least one of the following processings: detecting a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and detecting dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

Alternatively, in the case that the processor detects the synchronization signal corresponding to the ID of the carrier or cell in accordance with the ID of the carrier or cell pre-configured through the configuration signaling, the processor is further configured to detect the synchronization signal corresponding to the ID of the carrier or cell in each subframe or a predetermined subframe in which the synchronization signal is to be transmitted in accordance with the ID of the carrier or cell pre-configured through the configuration signaling. In the case that the processor detects the dedicated sequences pre-configured through the configuration signaling, the processor is further configured to detect the dedicated sequences in each subframe or a predetermined subframe, and the predetermined subframe is a particular subframe pre-configured through the configuration signaling, or a subframe determined in accordance with a detection period, or the detection period and a subframe offset value, pre-configured through the configuration signaling.

Alternatively, the processor is further configured to determine sequences of a particular reference signal for measurement pre-configured for the UE through the configuration signaling as the dedicated sequences, and/or detect the dedicated sequences in an energy detection manner.

Alternatively, the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or a subframe or OFDM symbol for transmitting the synchronization signal on the carrier or cell which uses the predetermined spectrum resource is acquired in advance in accordance with the configuration signaling; or an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol and the offset value.

Alternatively, the synchronization signal includes a PSS and/or an SSS.

Alternatively, the transceiver is further configured to notify a bandwidth of the carrier or cell which uses the predetermined spectrum in advance through the configuration signaling, or in the case that the bandwidth of the carrier or cell which uses the predetermined spectrum resource is unknown, receive the reference signal for measurement and performs the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the transceiver or the processor is further configured to determine the predetermined spectrum resource as an unlicensed spectrum resource.

Alternatively, the transceiver is further configured to determine the a secondary carrier or secondary cell pre-configured for the UE through the configuration signaling as the serving carrier or serving cell, and/or determine the carrier or cell which uses the predetermined spectrum resource as a secondary carrier or secondary cell pre-configured for the UE through the configuration signaling.

In still yet another aspect, the present disclosure provides in some embodiments a signal transmission apparatus for a base station, including a processor, a transceiver and a memory. The processor is configured to read a program stored in the memory and generate a signal. The transceiver is configured to receive and transmit the signal under the control of the processor. The transceiver is further configured to transmit the signal on a carrier or cell which uses a predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, the judge signal is further used for measurement.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

Alternatively, the processor is further configured to determine whether or not a current channel resource on the carrier or cell which uses the predetermined spectrum resource is free. In the case that the current channel resource is free, the transceiver is configured to transmit the signal on the carrier or cell which uses the predetermined spectrum resource. In the case that the current channel resource is busy, the transceiver is configured to prohibit the transmission of the signal on the carrier or cell which uses the predetermined spectrum resource, or transmit the signal on the carrier or cell which uses the predetermined spectrum resource after a predetermined time period. The predetermined time period has a length of a pre-defined fixed value, or the length of the predetermined time period is notified to the UE in advance through signaling.

Alternatively, in the case that the judge signal is a synchronization signal corresponding to an ID Of the carrier or cell which uses the predetermined spectrum resource, the transceiver is configured to transmit the synchronization signal and the reference signal for measurement and/or the data signal, or transmit the synchronization signal, or transmit the synchronization signal and the data signal, on the carrier or cell which uses the predetermined spectrum resource. The transceiver is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling. Alternatively, the transceiver is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling. Alternatively, the transceiver is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling.

Alternatively, in the case that the judge signal is dedicated sequences corresponding to the carrier or cell which uses the predetermined spectrum resources or dedicated sequences of the UE, the transceiver is configured to transmit the dedicated sequences and a reference signal for measurement and/or a data signal, or transmit the dedicated sequences, or transmit the dedicated sequences and the data signal, on the carrier or cell which uses the predetermined spectrum resources. The transceiver is further configured to transmit the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transceiver is further configured to transmit the dedicated sequences in each subframe or a pre-defined subframe on the carrier or cell which uses the predetermined spectrum resource, the dedicated sequences are pre-configured by the base station for the UE through the configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transceiver is further configured to transmit the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

Alternatively, the transceiver is further configured to transmit the reference signal for measurement on an OFDM symbol on which synchronization signals are currently transmitted and using all frequency domain resources other than the frequency domain resources occupied by the synchronization signals, or transmit the reference signal for measurement on an OFDM symbol on which synchronization signals are currently transmitted and using parts of the frequency domain resources other than the frequency domain resources occupied by the synchronization signals, or transmit the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or transmit the synchronization signal as the reference signal for measurement.

Alternatively, the processor is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific measurement reference signal and pre-configured through configuration signaling as sequences of the reference signal for measurement.

Alternatively, the processor is further configured to perform at least one of RSRP measurement, RSRQ measurement, positioning measurement, tracking measurement and CSI measurement using the reference signal for measurement.

Alternatively, the processor is further configured to determine sequences of a particular reference signal for measurement pre-configured for the UE through the configuration signaling as the dedicated sequences.

Alternatively, the transceiver is further configured to determine that: the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling; or the subframe or OFDM symbol for transmitting the synchronization signal on the carrier or cell which uses the predetermined spectrum resource is determined in accordance with a pre-defined position of the subframe or OFDM symbol and an offset value for transmitting the synchronization signal on the carrier or cell which uses the predetermined spectrum resource. The offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling.

Alternatively, the synchronization signal includes a PSS and/or an SSS.

Alternatively, the transceiver is further configured to notify a bandwidth of the carrier or cell which uses the predetermined spectrum resource to the UE in advance through signaling; or notify the bandwidth of the carrier or cell which uses the predetermined spectrum resource to a master base station in advance, so that the master base station notifies the bandwidth to the UE in advance through signaling, or in the case that the bandwidth of the carrier or cell which uses the predetermined spectrum resource is not notified by the base station or the master base station to the UE in advance through the configuration signaling, determine that the UE receives the reference signal for measurement and perform the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the transceiver is further configured to determine the predetermined spectrum resource as an unlicensed spectrum resource, and/or determine a secondary carrier or secondary cell pre-configured for the UE through the configuration signaling as the serving carrier or serving cell.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIGS. 1a and 1b are schematic views showing mapping positions of synchronization signals in the related art;

FIG. 2 is a schematic view showing the principle of resource preemption of unlicensed spectrum resources for a WiFi system;

FIG. 3 is a flow chart of a signal transmission method according to one embodiment of the present disclosure;

FIG. 4 is a flow chart of a further signal transmission method according to one embodiment of the present disclosure;

FIG. 5 is a block diagram of a signal transmission apparatus according to one embodiment of the present disclosure;

FIG. 6 is a block diagram of a further signal transmission apparatus according to one embodiment of the present disclosure;

FIG. 7 is a schematic view showing a computer for implementing the present disclosure;

FIG. 8 is another block diagram of the signal transmission apparatus according to one embodiment of the present disclosure; and

FIG. 9 is another block diagram of the further signal transmission apparatus according to one embodiment of the present disclosure.

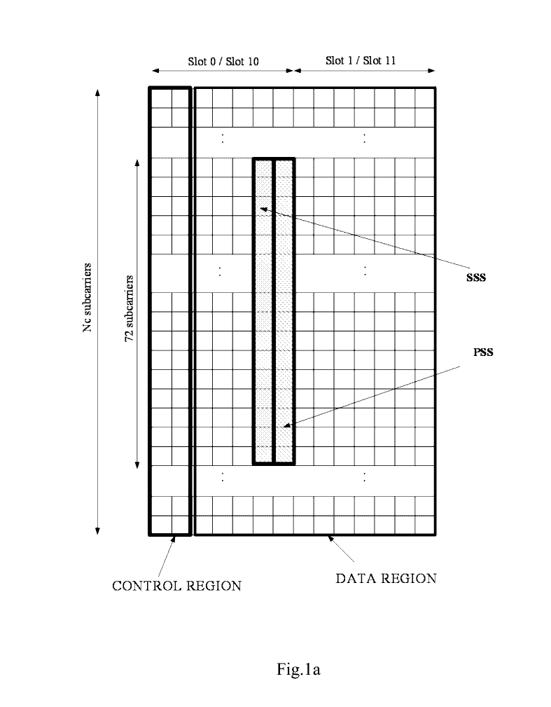

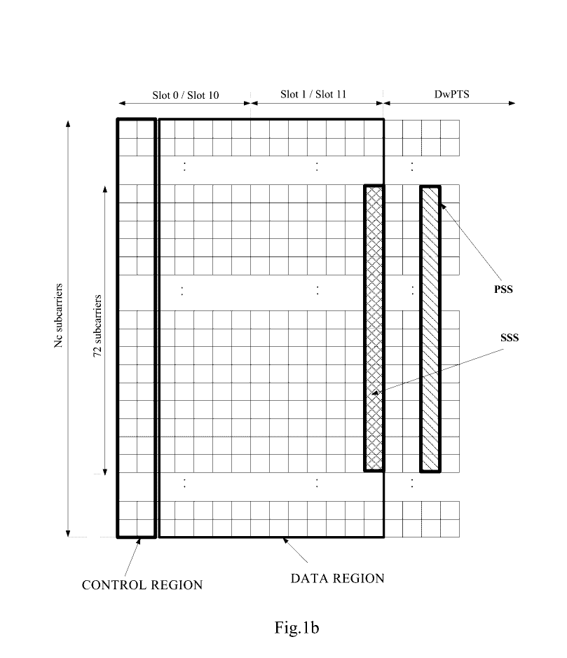

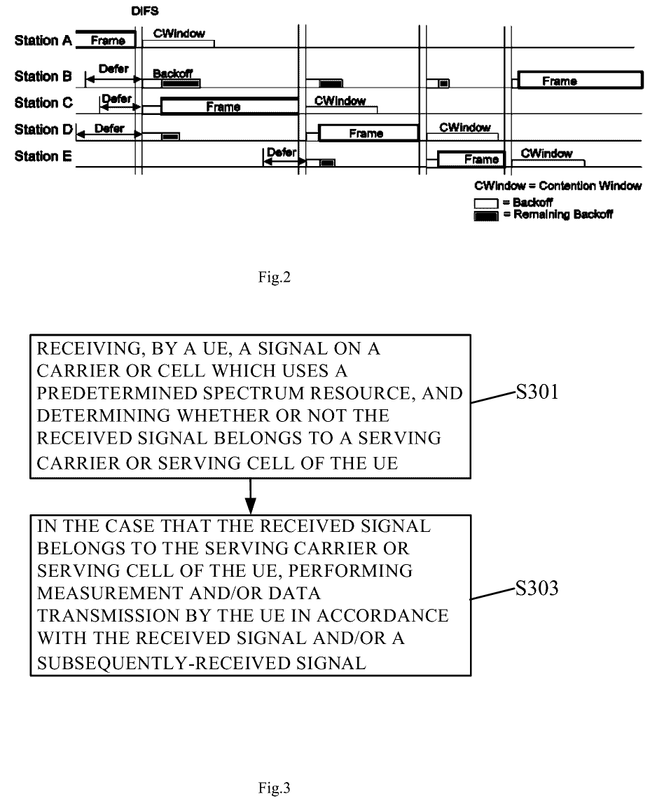

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

It should be appreciated that, the present disclosure may be applied to various communication systems, e.g., a Global System of Mobile communication (GSM) system, a Code Division Multiple Access (CDMA) system, a Wideband Code Division Multiple Access (WCDMA) system, a General Packet Radio Service (GPRS) system, a Long Term Evolution (LTE) system, an Advanced Long Term Evolution (LTE-A) system, a Universal Mobile Telecommunication System (UMTS), and so on.

It should be further appreciated that, in the embodiments of the present disclosure, a UE may include, but not limited to, a Mobile Station (MS), a mobile terminal, a mobile telephone, a handset and a portable equipment. The UE may communicate with one or more core networks via a Radio Access Network (RAN). For example, the UE may be a mobile telephone (or a cellular phone), a computer having a function of radio communication, a portable, pocket-size or handheld device, a device built in a computer, or a vehicle-mounted device.

In the embodiments of the present disclosure, a base station (e.g., an access point) may refer to a device in an access network, which communicates with a radio terminal over an air interface through one or more sectors. The base station may be used to convert a received air frame from/to an Internet Protocol (IP) packet, and it functions as a router between the radio terminal and other parts of the core network, including an IP network. The base station may also be used coordinate the attribute management over the air interface. For example, the base station may be a Base Transceiver Station (BTS) for the GSM or CDMA system, a NodeB for the WCDMA system, or an evolved NodeB (eNB) for the LTE system, which are not particularly defined herein.

It should be further appreciated that, in order to prevent the present disclosure from being blurred due to unnecessary details, the drawings merely show the structures and/or steps closely related to the present disclosure, with the other details being omitted.

The present disclosure provides in some embodiments a signal transmission method applicable to a terminal side. As shown in FIG. 3, the signal transmission method includes Step S301 of receiving, by a UE, a signal on a carrier or cell which uses a predetermined spectrum resource, and determining whether or not the received signal belongs to a serving carrier or serving cell of the UE; and Step 303 of in the case that the received signal belongs to the serving carrier or serving cell of the UE, performing measurement and/or data transmission by the UE in accordance with the received signal and/or a subsequently-received signal.

Alternatively, the step of performing the measurement and/or data transmission by the UE in accordance with the received signal and/or the subsequently-received signal includes at least one of: performing the measurement by the UE in accordance with a received reference signal for measurement; receiving by the UE a further reference signal for measurement, and performing the measurement in accordance with the received further reference signal for measurement; performing the data transmission by the UE in accordance with received scheduling signaling; and receiving by the UE further scheduling signaling, and performing the data transmission in accordance with the received further scheduling signaling.

For example, the UE may determine whether or not the received signal belongs to the serving cell, and if yes, it may further receive the reference signal for measurement, and perform the measurement in accordance with the reference signal for measurement. Alternatively, the UE may further receive the scheduling signaling and perform the data transmission in accordance with the scheduling signaling.

In an alternative embodiment, in the case of the signal transmission, the UE may receive the reference signal for measurement, and the reference signal is transmitted on an OFDM symbol on which synchronization signals are currently transmitted and using frequency domain resources other than the frequency domain resources occupied by the synchronization signals. The UE may then perform the measurement in accordance with the reference signal.

Alternatively, the reference signal for measurement is transmitted on the OFDM symbol on which the synchronization signals are currently transmitted and using all the frequency domain resources other than the frequency domain resources occupied by the synchronization signals. For example, in an alternative embodiment, reference symbols may be continuously mapped to the OFDM symbol on which the synchronization signals are currently transmitted in a current carrier or cell, and transmitted using all resource elements (REs) other than the REs occupied by the synchronization signals in a bandwidth of the carrier or cell.

Alternatively, the reference signal for measurement is transmitted on the OFDM symbol on which the synchronization signals are currently transmitted and using parts of the frequency domain resources other than the frequency domain resources occupied by the synchronization signals. For example, in an alternative embodiment, the reference symbols may be divided into several groups, and each group may be mapped, in accordance with a fixed RE interval, to the Res, other than those occupied by the synchronization signals, of the OFDM symbol on which the synchronization signals are currently transmitted on a carrier. Each group may occupy at least one continuous RE.

Alternatively, the reference signal for measurement is transmitted on the OFDM symbol adjacent to, or separated by a fixed time domain interval from, the OFDM symbol on which synchronization signals are currently transmitted and the reference signal for measurement and at least one synchronization signal in the synchronization signals are transmitted within an identical subframe. In an alternative embodiment, the reference signal for measurement is transmitted, in a frequency domain, on all or parts of the frequency resources in a cell on the OFDM symbol. During the mapping, the reference signal may be mapped to the continuous REs of the OFDM symbol, or discretely mapped to discontinuous REs. For example, a group of reference signals may be mapped in accordance with a fixed RE interval, and they may occupy at least one continuous RE.

Alternatively, the reference signal for measurement may be the synchronization signal, i.e., the UE may perform the measurement directly in accordance with the synchronization signal, without any need to receive the measurement signal.

In addition, the reference signal for measurement is used for at least one of RSRP measurement, RSRQ measurement, positioning measurement, tracking measurement and CSI measurement.

To be specific, sequences of the reference signal for measurement are generated at least in association with an ID of a carrier or cell on which the reference signal is currently transmitted, or in the case that the reference signal for measurement is used for measuring RSRP and/or CSI, sequences of the reference signal for measurement are generated at least in association with an ID of a carrier or cell on which the reference signal is currently transmitted, or sequences of the reference signal for measurement are sequences of a UE-specific or cell-specific measurement reference signal and pre-configured through high-layer signaling, or in the case that the reference signal for measurement is used for measuring CSI, sequences of the reference signal for measurement is sequences of a UE-specific or cell-specific measurement reference signal and pre-configured through configuration signaling.

Alternatively, the configuration signaling may be high-layer signaling or configuration signaling transmitted over a control channel such as a Physical Downlink Control Channel (PDCCH) or an Enhanced Physical Downlink Control Channel (E-PDCCH). The configuration signal may be transmitted by a base station or a network side to the UE via a primary carrier or cell of the UE. The base station transmitting the configuration signaling may be a base station which serves a current carrier or cell, or a master base station of the UE. In the case that the UE is served by a plurality of base stations, the base station transmitting the configuration signaling is the master base station that serves the UE.

In addition, unless otherwise specified, during the configuration for the UE, the configuration signaling may be transmitted as mentioned above in the context.

Alternatively, the step of determining by the UE whether or not the received signal belongs to the serving carrier or serving cell includes at least one of: detecting, by the UE, a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and detecting, by the UE, dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

Alternatively, the step of detecting, by the UE, the synchronization signal corresponding to the ID of the carrier or cell in accordance with the ID of the carrier or cell pre-configured through the configuration signaling includes detecting, by the UE, the synchronization signal corresponding to the ID of the carrier or cell in each subframe or a predetermined subframe in which the synchronization signal is to be transmitted in accordance with the ID of the carrier or cell pre-configured through the configuration signaling. The step of detecting, by the UE, the dedicated sequences pre-configured through the configuration signaling includes detecting, by the UE, the dedicated sequences in each subframe or a predetermined subframe, the predetermined subframe being a particular subframe pre-configured through the configuration signaling, or a subframe determined in accordance with a detection period, or the detection period and a subframe offset value, pre-configured through the configuration signaling.

The dedicated sequences may be sequences of a particular reference signal for measurement pre-configured for the UE through the configuration signaling, i.e., the dedicated sequences may also be used for the measurement. At this time, it is unnecessary for the UE to receive the measurement signal.

Alternatively, the terminal may detect the dedicated sequences in an energy detection manner.

In addition, the synchronization signal may be transmitted on the carrier or cell which uses the predetermined spectrum resource and using a subframe and a frequency domain resource defined in LTE releases 8-11 for a FDD or TDD system.

Alternatively, the synchronization signal may be mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource.

Alternatively, the synchronization signal may be mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal may be mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal may be mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource.

Alternatively, a subframe or OFDM symbol for transmitting the synchronization signal on the carrier or cell which uses the predetermined spectrum resource may be acquired in advance in accordance with the configuration signaling. There may be one or more carriers or cells. In the case that there are a plurality of carriers or cells, the subframes or OFDM symbols for transmitting the synchronization signals on the carriers or cells may be identical to, or different from, each other, the subframe or OFDM symbol may be configured once, or the configuration may be updated at a fixed period, or the configuration may be updated in the case that the available resources of the predetermined spectrum resources are changed.

Alternatively, an offset value for transmitting the synchronization signal on the carrier or cell which uses the predetermined spectrum resource may be acquired in advance in accordance with the configuration signaling, and then the UE may determine a subframe or OFDM symbol for transmitting the synchronization signal on the carrier or cell which uses the predetermined spectrum resource in accordance with a pre-defined position of the subframe or OFDM symbol and the offset value. There may be one or more carriers or cells. In the case that there are a plurality of carriers or cells, the offset values for transmitting the synchronization signals and configured for each carrier or cell may be identical to, or different from, each other. The offset value may be configured once, or the configuration may be updated at a fixed period, or the configuration may be updated in the case that the available resources of the predetermined spectrum resources are changed.

In the mapping mode of the synchronization signal, alternatively, the pre-defined subframe for transmitting the synchronous signal is the subframe for transmitting the synchronization signal defined in LTE releases 8-11 for the FDD or TDD system. The available subframe may be a free subframe or downlink subframe on the predetermined spectrum resources (i.e., no data for the other system is transmitted in the subframe). In addition, the synchronization signal may include a PSS and/or an SSS, i.e., it may include the PSS, the SSS, or both of them.

In the signal transmission method, a bandwidth of the carrier or cell which uses the predetermined spectrum resource is notified in advance through the configuration signaling, or in the case that the bandwidth of the carrier or cell which uses the predetermined spectrum resource is unknown, the UE receives the reference signal for measurement on a pre-defined bandwidth in the middle of the carrier or cell which uses the predetermined spectrum resource and performs the measurement, and the pre-defined bandwidth is of a value not less than 6 RBs, or a value not less than a minimum bandwidth defined in an LTE system. Alternatively, the minimum bandwidth may be 6 RBs, or any other value.

Alternatively, the predetermined spectrum resource may be an unlicensed spectrum resource. In addition, the signal transmission method in the embodiments of the present disclosure may also be applied to a system where licensed spectrum resources are used.

In addition, the carrier or cell is a secondary carrier or secondary cell pre-configured for the UE through the configuration signaling. Alternatively, the carrier or cell which uses the predetermined spectrum resource is a secondary carrier or secondary cell pre-configured for the UE through the configuration signaling.

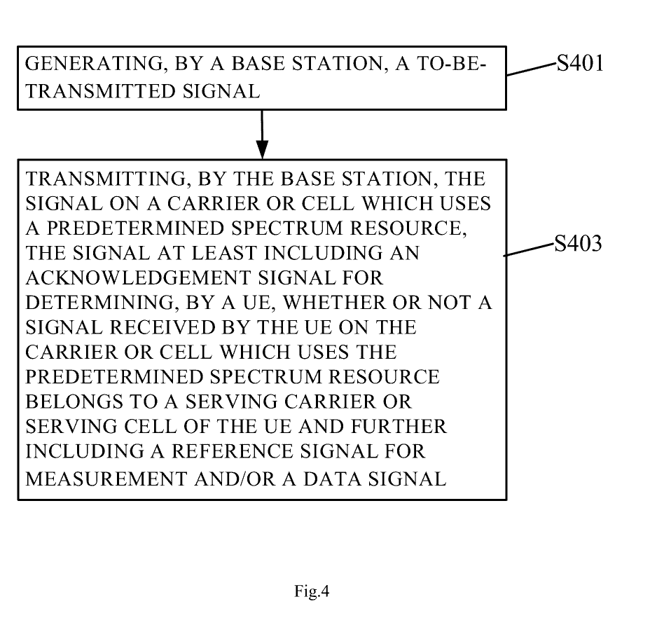

The present disclosure further provides in some embodiments a signal transmission method for a network side, e.g., a base station. As shown in FIG. 4, the signal transmission method includes Step S401 of generating, by the base station, a to-be-transmitted signal, and Step S403 of transmitting, by the base station, the signal on a carrier or cell which uses a predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, the judge signal is further used for measurement.

In the case that the base station transmits the reference signal and/or the data signal while transmitting the judge signal, the UE may receive these signals and determine the cell to which the reference signal and/or the data signal belong in accordance with the judge signal. In the case that the reference signal and/or the data signal belong to the serving cell, the UE may perform the measurement in accordance with the reference signal for measurement, and further receive the data signal. In an alternative embodiment, the judge signal is provided so that the UE may determine the cell to which the signal belong and meanwhile perform the measurement. At this time, even if no reference signal for measurement is transmitted from the base station, the judge signal may also be used for the measurement.

Alternatively, prior to Step S401, the signal transmission method may further include: determining, by the base station, whether or not a current channel resource on the carrier or cell which uses the predetermined spectrum resource is free; in the case that the current channel resource is free, transmitting, by the base station, the signal on the carrier or cell which uses the predetermined spectrum resource; and in the case that the current channel resource is busy, prohibiting, by the base station, the transmission of the signal on the carrier or cell which uses the predetermined spectrum resource, or transmitting, by the base station, the signal on the carrier or cell which uses the predetermined spectrum resource after a predetermined time period. The predetermined time period has a length of a pre-defined fixed value, or the length of the predetermined time period is notified to the UE in advance through signaling.

Alternatively, the judge signal is a synchronization signal corresponding to an ID Of the carrier or cell which uses the predetermined spectrum resource, and the base station transmits the synchronization signal and the reference signal for measurement and/or the data signal, or transmits the synchronization signal, or transmits the synchronization signal and the data signal, on the carrier or cell which uses the predetermined spectrum resource. The base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling (e.g., the configuration signaling may be transmitted on the primary carrier or cell of the UE, and in the case that the UE is configured through the configuration signaling, the ID of the cell may be configured for the UE whose serving carrier or cell is the carrier or cell which uses the predetermined spectrum resource). Alternatively, the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling (e.g., in the case that the base station serves the primary carrier or cell of the UE, it may pre-configure the ID of the carrier or cell which uses the predetermined spectrum resource for the UE through the high-layer signaling transmitted on the primary carrier or cell, and the ID of the carrier or cell may be configured to the UE whose serving carrier or cell is the carrier or cell which uses the predetermined spectrum resource). Alternatively, the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling.

Alternatively, the judge signal is dedicated sequences corresponding to the carrier or cell which uses the predetermined spectrum resources or dedicated sequences of the UE, and the base station transmits the dedicated sequences and a reference signal for measurement and/or a data signal, or transmits the dedicated sequences, or transmits the dedicated sequences and the data signal, on the carrier or cell which uses the predetermined spectrum resources. The base station transmits the dedicated sequences in each subframe or a pre-defined subframe on the carrier or cell which uses the predetermined spectrum resource, the dedicated sequences are pre-configured by a master base station for the UE through configuration signaling (e.g., the dedicated sequences may be configured for the UE whose serving carrier or cell is the carrier or cell which uses the predetermined spectrum resource), and the pre-defined subframe is a particular subframe pre-configured through the configuration signaling or a subframe determined in accordance with a detection period, or the detection period and a subframe offset value, pre-configured through the configuration signaling. Alternatively, the base station transmits the dedicated sequences in each subframe or a pre-defined subframe on the carrier or cell which uses the predetermined spectrum resource, the dedicated sequences are pre-configured by the base station for the UE through the configuration signaling (e.g., the dedicated sequences may be configured for the UE whose serving carrier or cell is the carrier or cell which uses the predetermined spectrum resource), and the pre-defined subframe is a particular subframe pre-configured through the configuration signaling or a subframe determined in accordance with a detection period, or the detection period and a subframe offset value, pre-configured through the configuration signaling. Alternatively, the base station transmits the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling (e.g., the dedicated sequences may be configured for the UE whose serving carrier or cell is the carrier or cell which uses the predetermined spectrum resource), and the pre-defined subframe is a particular subframe pre-configured through the configuration signaling or a subframe determined in accordance with a detection period, or the detection period and a subframe offset value, pre-configured through the configuration signaling.

The reference signal for measurement is transmitted on the OFDM symbol on which the synchronization signals are currently transmitted and using all the frequency domain resources other than the frequency domain resources occupied by the synchronization signals, For example, in an alternative embodiment, reference symbols may be continuously mapped to the OFDM symbol on which the synchronization signals are currently transmitted in a current carrier or cell, and transmitted using all REs other than the REs occupied by the synchronization signals in a bandwidth of the carrier or cell. Alternatively, the reference signal for measurement is transmitted on the OFDM symbol on which the synchronization signals are currently transmitted and using parts of the frequency domain resources other than the frequency domain resources occupied by the synchronization signals. For example, in an alternative embodiment, the reference symbols may be divided into several groups, and each group may be mapped, in accordance with a fixed RE interval, to a carrier, and then transmitted on the OFDM symbol on which the synchronization signals are currently transmitted and using the REs other than those occupied by the synchronization signals. Each group may occupy at least one continuous RE. Alternatively, the reference signal for measurement is transmitted on the OFDM symbol adjacent to, or separated by a fixed time domain interval from, the OFDM symbol on which synchronization signals are currently transmitted, and the reference signal for measurement and at least one synchronization signal in the synchronization signals are transmitted within an identical subframe. In an alternative embodiment, the reference signal for measurement is transmitted, in a frequency domain, on all or parts of the frequency resources in a cell on the OFDM symbol. During the mapping, the reference signal may be mapped to the continuous REs of the OFDM symbol, or discretely mapped to discontinuous REs. For example, a group of reference signals may be mapped in accordance with a fixed RE interval, and they may occupy at least one continuous RE. Alternatively, the reference signal for measurement may be the synchronization signal.

Alternatively, the reference signal for measurement is used for at least one of RSRP measurement, RSRQ measurement, positioning measurement, tracking measurement and CSI measurement.

To be specific, sequences of the reference signal for measurement are generated at least in association with an ID of a carrier or cell on which the reference signal is currently transmitted, or in the case that the reference signal for measurement is used for measuring RSRP and/or CSI, sequences of the reference signal for measurement are generated at least in association with an ID of a carrier or cell on which the reference signal is currently transmitted, or sequences of the reference signal for measurement are sequences of a UE-specific or cell-specific measurement reference signal and pre-configured through high-layer signaling, or in the case that the reference signal for measurement is used for measuring CSI, sequences of the reference signal for measurement is sequences of a UE-specific measurement reference signal and pre-configured through configuration signaling.

In addition, the dedicated sequences may be sequences of a particular reference signal for measurement pre-configured for the UE through the configuration signaling.

In addition, the synchronization signal may be transmitted on the carrier or cell which uses the predetermined spectrum resource and using a subframe and a frequency domain resource defined in LTE releases 8-11 for a FDD or TDD system.

Alternatively, the synchronization signal may be mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource.

Alternatively, the synchronization signal may be mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal may be mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal may be mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource.

Alternatively, the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling. There may be one or more carriers or cells. In the case that there are a plurality of carriers or cells, the subframes or OFDM symbols for transmitting the synchronization signals on the carriers or cells may be identical to, or different from, each other, the subframe or OFDM symbol may be configured once, or the configuration may be updated at a fixed period, or the configuration may be updated in the case that the available resources of the predetermined spectrum resources are changed.

Alternatively, the subframe or OFDM symbol for transmitting the synchronization signal is determined in accordance with a pre-defined position of the subframe or OFDM symbol and an offset value for transmitting the synchronization signal on the carrier or cell which uses the predetermined spectrum resource. The offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling. The offset values for transmitting the synchronization signals and configured for each carrier or cell may be identical to, or different from, each other. The offset value may be configured once, or the configuration may be updated at a fixed period, or the configuration may be updated in the case that the available resources of the predetermined spectrum resources are changed.

In the mapping mode of the synchronization signal, alternatively, the pre-defined subframe for transmitting the synchronous signal is the subframe for transmitting the synchronization signal defined in LTE releases 8-11 for the FDD or TDD system. The available subframe may be a free subframe or downlink subframe on the predetermined spectrum resources (i.e., no data for the other system is transmitted in the subframe). In addition, the synchronization signal may include a PSS and/or an SSS.

In addition, in the embodiments of the present disclosure, a bandwidth of the carrier or cell which uses the predetermined spectrum resource is notified by the base station to the UE in advance through signaling; or the bandwidth of the carrier or cell which uses the predetermined spectrum resource is notified by the base station to a master base station in advance, and notified by the master base station to the UE in advance through signaling; or the bandwidth of the carrier or cell which uses the predetermined spectrum resource is notified by the master base station to the UE in advance through configuration signaling. In the case that the bandwidth of the carrier or cell which uses the predetermined spectrum resource is not notified by the base station or the master base station to the UE in advance through the configuration signaling, the base station determines that the UE receives the reference signal for measurement and perform the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system (e.g., the bandwidth may be 6 RBs).

Alternatively, the predetermined spectrum resource is an unlicensed spectrum resource.

In addition, the carrier or cell is a secondary carrier or secondary cell pre-configured for the UE through the configuration signaling.

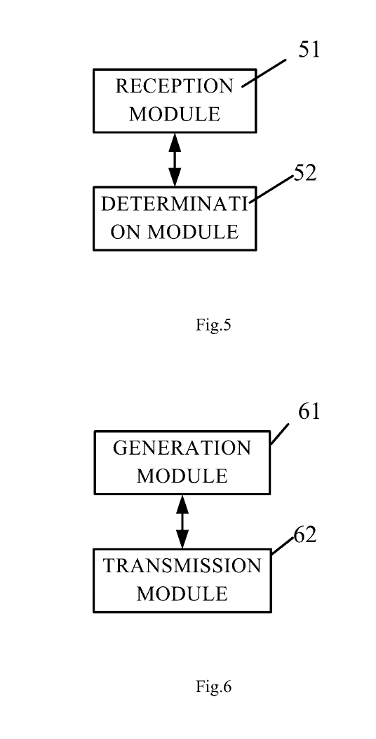

The present disclosure further provides in some embodiments a signal transmission apparatus which, as shown in FIG. 5, includes: a reception module 51 configured to receive a signal; and a determination module 52 configured to, in the case that the reception module receives the signal on a carrier or cell which uses a predetermined spectrum resource, determines whether or not the received signal belongs to a serving carrier or serving cell of a UE. The reception module 51 is further configured to, in the case that the received signal belongs to the serving carrier or serving cell of the UE, perform measurement and/or data transmission in accordance with the received signal and/or a subsequently-received signal.

Alternatively, the reception module 51 is further configured to perform at least one of the following processings: performing the measurement by the UE in accordance with a received reference signal for measurement; receiving a further reference signal for measurement, and performing the measurement in accordance with the received further reference signal for measurement; performing the data transmission in accordance with received scheduling signaling; and receiving further scheduling signaling, and performing the data transmission in accordance with the received further scheduling signaling.

Alternatively, the reception module 51 is further configured to receive the reference signal for measurement on an OFDM symbol on which synchronization signals are currently transmitted and using all frequency domain resources other than the frequency domain resources occupied by the synchronization signals, or receive the reference signal for measurement on an OFDM symbol on which synchronization signals are currently transmitted and using parts of the frequency domain resources other than the frequency domain resources occupied by the synchronization signals, or receive the reference signal for measurement on an OFDM symbol adjacent to, or separated by a fixed time domain interval from, the OFDM symbol on which synchronization signals are currently transmitted, wherein the reference signal for measurement and at least one synchronization signal in the synchronization signals are transmitted within an identical subframe, or receive the synchronization signal as the reference signal for measurement.

Alternatively, the reception module 51 is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific or cell-specific measurement reference signal and pre-configured through configuration signaling as sequences of the reference signal for measurement.

Alternatively, the reception module 51 is further configured to perform at least one of RSRP measurement, RSRQ measurement, positioning measurement, tracking measurement and CSI measurement using the reference signal for measurement.

In addition, the determination module 52 is further configured to perform at least one of the following processings: detecting a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and detecting dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

In addition, in the case that the determination module 52 detects the synchronization signal corresponding to the ID of the carrier or cell in accordance with the ID of the carrier or cell pre-configured through the configuration signaling, the determination module 52 is further configured to detect the synchronization signal corresponding to the ID of the carrier or cell in each subframe or a predetermined subframe in which the synchronization signal is to be transmitted in accordance with the ID of the carrier or cell pre-configured through the configuration signaling. In the case that the determination module 52 detects the dedicated sequences pre-configured through the configuration signaling, the determination module 52 is further configured to detect the dedicated sequences in each subframe or a predetermined subframe, and the predetermined subframe is a particular subframe pre-configured through the configuration signaling, or a subframe determined in accordance with a detection period, or the detection period and a subframe offset value, pre-configured through the configuration signaling.

In addition, the determination module 52 is further configured to determine sequences of a particular reference signal for measurement pre-configured for the UE through the configuration signaling as the dedicated sequences. Alternatively, the determination module 52 may be further configured to detect the dedicated sequences in an energy detection manner.

In addition, the synchronization signal is transmitted on the carrier or cell which uses the predetermined spectrum resource and using a subframe and a frequency domain resource defined in LTE releases 8-11 for a FDD or TDD system.

Alternatively, the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource.

Alternatively, the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource.

Alternatively, a subframe or OFDM symbol for transmitting the synchronization signal on the carrier or cell which uses the predetermined spectrum resource is acquired in advance in accordance with the configuration signaling.

Alternatively, an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol and the offset value.

In addition, the synchronization signal may include a PSS and/or an SSS.

In addition, a bandwidth of the carrier or cell which uses the predetermined spectrum resource is notified in advance through the configuration signaling, or in the case that the bandwidth of the carrier or cell which uses the predetermined spectrum resource is unknown, the UE receives the reference signal for measurement and performs the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

In addition, the predetermined spectrum resource is an unlicensed spectrum resource. The carrier or cell is a secondary carrier or secondary cell pre-configured for the UE through the configuration signaling. Alternatively, the carrier or cell which uses the predetermined spectrum resource is a secondary carrier or secondary cell pre-configured for the UE through the configuration signaling.

The present disclosure further provides in some embodiments a signal transmission apparatus for a base station. As shown in FIG. 6, the signal transmission apparatus includes: a generation module 61 configured to generate a signal; and a transmission module 62 configured to transmit the signal on a carrier or cell which uses a predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, the judge signal is further used for measurement.

Alternatively, the signal transmission apparatus may further include a judgment module (not shown) configured to determine whether or not a current channel resource on the carrier or cell which uses the predetermined spectrum resource is free. In the case that the current channel resource is free, the transmission module 62 is further configured to transmit the signal on the carrier or cell which uses the predetermined spectrum resource, and in the case that the current channel resource is busy, the transmission module 62 is further configured to prohibit the transmission of the signal on the carrier or cell which uses the predetermined spectrum resource, or transmit the signal on the carrier or cell which uses the predetermined spectrum resource after a predetermined time period. The predetermined time period has a length of a pre-defined fixed value, or the length of the predetermined time period is notified to the UE in advance through signaling.

In addition, in the case that the judge signal is a synchronization signal corresponding to an ID of the carrier or cell which uses the predetermined spectrum resource, the transmission module 62 is configured to transmit the synchronization signal and the reference signal for measurement and/or the data signal, or transmit the synchronization signal, or transmit the synchronization signal and the data signal, on the carrier or cell which uses the predetermined spectrum resource. The transmission module 62 is configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling. Alternatively, the transmission module 62 is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling. Alternatively, the transmission module 62 is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling.

Alternatively, in the case that the judge signal is dedicated sequences corresponding to the carrier or cell which uses the predetermined spectrum resources or dedicated sequences of the UE, the transmission module 62 is configured to transmit the dedicated sequences and a reference signal for measurement and/or a data signal, or transmit the dedicated sequences, or transmit the dedicated sequences and the data signal, on the carrier or cell which uses the predetermined spectrum resources. The transmission module 62 is further configured to transmit the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transmission module 62 is further configured to transmit the dedicated sequences in each subframe or a pre-defined subframe on the carrier or cell which uses the predetermined spectrum resource, the dedicated sequences are pre-configured by the base station for the UE through the configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transmission module 62 is further configured to transmit the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

In addition, the transmission module 62 is further configured to transmit the reference signal for measurement on an OFDM symbol on which synchronization signals are currently transmitted and using all frequency domain resources other than the frequency domain resources occupied by the synchronization signals, or transmit the reference signal for measurement on an OFDM symbol on which synchronization signals are currently transmitted and using parts of the frequency domain resources other than the frequency domain resources occupied by the synchronization signals, or transmit the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or transmit the synchronization signal as the reference signal for measurement.

In addition, the generation module 61 is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific measurement reference signal and pre-configured through configuration signaling as sequences of the reference signal for measurement.

Alternatively, the generation module 61 is further configured to perform at least one of RSRP measurement, RSRQ measurement, positioning measurement, tracking measurement and CSI measurement using the reference signal for measurement.

In addition, the dedicated sequences are sequences of a particular reference signal for measurement pre-configured for the UE through the configuration signaling.

In addition, in the mapping mode of the synchronization signal, the synchronization signal is transmitted on the carrier or cell which uses the predetermined spectrum resource and using a subframe and a frequency domain resource defined in LTE releases 8-11 for a FDD or TDD system.

Alternatively, the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource.

Alternatively, the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource.

Alternatively, the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource.

Alternatively, the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling.

Alternatively, the subframe or OFDM symbol for transmitting the synchronization signal on the carrier or cell which uses the predetermined spectrum resource is determined in accordance with a pre-defined position of the subframe or OFDM symbol and an offset value for transmitting the synchronization signal on the carrier or cell which uses the predetermined spectrum resource. The offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling.

In addition, the synchronization signal includes a PSS and/or an SSS.

In addition, the transmission module 62 is further configured to: notify a bandwidth of the carrier or cell which uses the predetermined spectrum resource to the UE in advance through signaling; or notify the bandwidth of the carrier or cell which uses the predetermined spectrum resource to a master base station in advance, so that the master base station notifies the bandwidth to the UE in advance through signaling; or in the case that the bandwidth of the carrier or cell which uses the predetermined spectrum resource is not notified by the base station or the master base station to the UE in advance through the configuration signaling, determine that the UE receives the reference signal for measurement and perform the measurement on a pre-defined bandwidth in the middle of the carrier or cell which uses the predetermined spectrum resource. The pre-defined bandwidth is of a value not less than 6 RBs, or a value not less than a minimum bandwidth defined in an LTE system.

Alternatively, the predetermined spectrum resource is an unlicensed spectrum resource, and the carrier or cell is a secondary carrier or secondary cell pre-configured for the UE through the configuration signaling.

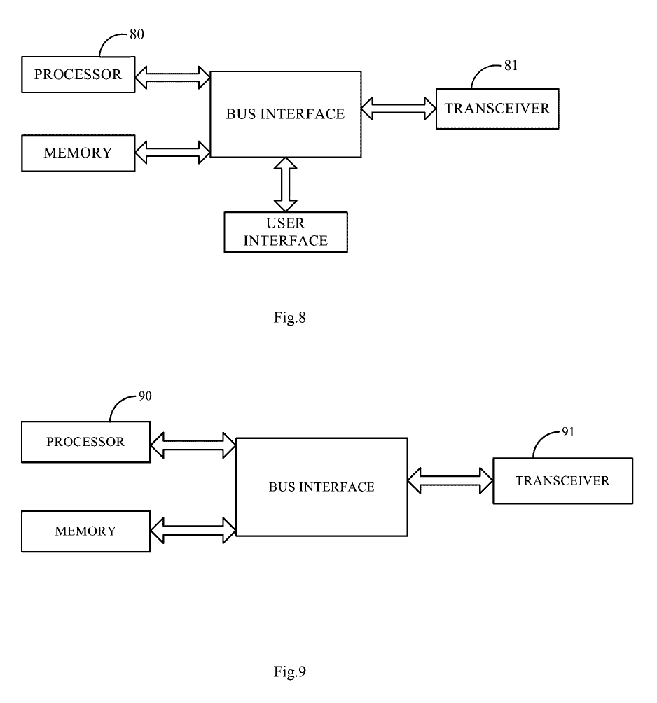

The present disclosure further provides in some embodiments a signal transmission apparatus which, as shown in FIG. 8, includes a transceiver 81, a processor 80 and a memory. The transceiver 81 is configured to receive and transmit a signal under the control of the processor. The processor 80 is configured to read a program stored in a memory so as to, in the case that the signal is received by the transceiver 81 on a carrier or cell which uses a predetermined spectrum resource, determine whether or not the received signal belongs to a serving carrier or serving cell of a UE. The transceiver 81 is further configured to, in the case that the received signal belongs to the serving carrier or serving cell of the UE, perform measurement and/or data transmission in accordance with the received signal and/or a subsequently-received signal.

Alternatively, the transceiver 81 is configured to perform at least one of the following processings: performing the measurement in accordance with a received reference signal for measurement; receiving a further reference signal for measurement, and performing the measurement in accordance with the received further reference signal for measurement; performing the data in accordance with received scheduling signaling; and receiving further scheduling signaling, and performing the data transmission in accordance with the received further scheduling signaling.

Alternatively, the transceiver 81 is further configured to receive the reference signal for measurement on an OFDM symbol on which synchronization signals are currently transmitted and using all frequency domain resources other than the frequency domain resources occupied by the synchronization signals, or receive the reference signal for measurement an OFDM symbol on which synchronization signals are currently transmitted and using parts of the frequency domain resources other than the frequency domain resources occupied by the synchronization signals, or receive the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or receive the synchronization signal as the reference signal for measurement.

Alternatively, the transceiver 81 is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific or cell-specific measurement reference signal and pre-configured through configuration signaling as sequences of the reference signal for measurement.

Alternatively, the transceiver 81 is further configured to perform at least one of RSRP measurement, RSRQ measurement, positioning measurement, tracking measurement and CSI measurement using the reference signal for measurement.

Alternatively, the processor 80 is configured to perform at least one of the following processings: detecting a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and detecting dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

Alternatively, in the case that the processor 80 detects the synchronization signal corresponding to the ID of the carrier or cell in accordance with the ID of the carrier or cell pre-configured through the configuration signaling, the processor 80 is further configured to detect the synchronization signal corresponding to the ID of the carrier or cell in each subframe or a predetermined subframe in which the synchronization signal is to be transmitted in accordance with the ID of the carrier or cell pre-configured through the configuration signaling. In the case that the processor 80 detects the dedicated sequences pre-configured through the configuration signaling, the processor 80 is further configured to detect the dedicated sequences in each subframe or a predetermined subframe, and the predetermined subframe is a particular subframe pre-configured through the configuration signaling, or a subframe determined in accordance with a detection period, or the detection period and a subframe offset value, pre-configured through the configuration signaling.

Alternatively, the processor 80 is further configured to determine sequences of a particular reference signal for measurement pre-configured for the UE through the configuration signaling as the dedicated sequences, and/or detect the dedicated sequences in an energy detection manner.

In addition, the synchronization signal is transmitted on the carrier or cell which uses the predetermined spectrum resource and using a subframe and a frequency domain resource defined in LTE releases 8-11 for a FDD or TDD system. Alternatively, the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource. Alternatively, the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource. Alternatively, the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource. Alternatively, the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource. Alternatively, a subframe or OFDM symbol for transmitting the synchronization signal on the carrier or cell which uses the predetermined spectrum resource is acquired in advance in accordance with the configuration signaling. Alternatively, an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol and the offset value.

In addition, the synchronization signal includes a PSS and/or an SSS.

Alternatively, the transceiver 81 is further configured to notify a bandwidth of the carrier or cell which uses the predetermined spectrum in advance through the configuration signaling, or in the case that the bandwidth of the carrier or cell which uses the predetermined spectrum resource is unknown, receive the reference signal for measurement and performs the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the transceiver 81 or the processor 80 is further configured to determine the predetermined spectrum resource as an unlicensed spectrum resource.

Alternatively, the transceiver 81 is further configured to determine as a secondary carrier or secondary cell pre-configured for the UE through the configuration signaling as the serving carrier or serving cell, and/or determine the carrier or cell which uses the predetermined spectrum resource as a secondary carrier or secondary cell pre-configured for the UE through the configuration signaling.

In FIG. 6, a bus architecture may include a number of buses and bridges connected to each other, so as to connect various circuits for one or more processors 80 and one or more memories. In addition, as is known in the art, the bus architecture may be used to connect any other circuits, such as a circuit for a peripheral device, a circuit for a voltage stabilizer and a power management circuit. Bus interfaces are provided, and the transceiver 81 may consist of more than one elements, e.g., a transmitter and a receiver for communication with any other devices over a transmission medium. With respect to different UEs, a user interface may also be provided for devices which are to be arranged inside or outside the UE, and these devices may include but not limited to a keypad, a display, a speaker, a microphone and a joystick. The processor 80 takes charge of managing the bus architecture as well as general processings. The memory may store therein data desired for the operation of the processor 80.

The present disclosure further provides in some embodiments a signal transmission apparatus for a base station. As shown in FIG. 9, the signal transmission apparatus includes a processor 90, a transceiver 91 and a memory. The processor 90 is configured to read a program stored in the memory and generate a signal. The transceiver 91 is configured to receive and transmit the signal under the control of the processor 90. The transceiver 91 is further configured to transmit the signal on a carrier or cell which uses a predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, the judge signal is further used for measurement.

Alternatively, the processor 90 is further configured to determine whether or not a current channel resource on the carrier or cell which uses the predetermined spectrum resource is free. In the case that the current channel resource is free, the transceiver 91 is configured to transmit the signal on the carrier or cell which uses the predetermined spectrum resource. In the case that the current channel resource is busy, the transceiver 91 is configured to prohibit the transmission of the signal on the carrier or cell which uses the predetermined spectrum resource, or transmit the signal on the carrier or cell which uses the predetermined spectrum resource after a predetermined time period. The predetermined time period has a length of a pre-defined fixed value, or the length of the predetermined time period is notified to the UE in advance through signaling.

In addition, in the case that the judge signal is a synchronization signal corresponding to an ID Of the carrier or cell which uses the predetermined spectrum resource, the transceiver 91 is configured to transmit the synchronization signal and the reference signal for measurement and/or the data signal, or transmit the synchronization signal, or transmit the synchronization signal and the data signal, on the carrier or cell which uses the predetermined spectrum resource. The transceiver 91 is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling. Alternatively, the transceiver 91 is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling. Alternatively, the transceiver 91 is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling.

Alternatively, in the case that the judge signal is dedicated sequences corresponding to the carrier or cell which uses the predetermined spectrum resources or dedicated sequences of the UE, the transceiver 91 is configured to transmit the dedicated sequences and a reference signal for measurement and/or a data signal, or transmit the dedicated sequences, or transmit the dedicated sequences and the data signal, on the carrier or cell which uses the predetermined spectrum resources. The transceiver 91 is further configured to transmit the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transceiver 91 is further configured to transmit the dedicated sequences in each subframe or a pre-defined subframe on the carrier or cell which uses the predetermined spectrum resource, the dedicated sequences are pre-configured by the base station for the UE through the configuration signaling, and the pre-defined subframe is a particular subframe pre-configured through the configuration signaling or a subframe determined in accordance with a detection period, or the detection period and a subframe offset value, pre-configured through the configuration signaling. Alternatively, the transceiver 91 is further configured to transmit the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

Alternatively, the transceiver 91 is further configured to transmit the reference signal for measurement on an OFDM symbol on which synchronization signals are currently transmitted and using all frequency domain resources other than the frequency domain resources occupied by the synchronization signals, or transmit the reference signal for measurement on an OFDM symbol on which synchronization signals are currently transmitted and using parts of the frequency domain resources other than the frequency domain resources occupied by the synchronization signals, or transmit the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or transmit the synchronization signal as the reference signal for measurement.

Alternatively, the processor 90 is further configured to generate sequences of the reference signal for measurement at least in association with an ID of a carrier or cell on which the reference signal is currently transmitted, or in the case that the reference signal for measurement is used for measuring RSRP and/or CSI, generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific measurement reference signal and pre-configured through configuration signaling as sequences of the reference signal for measurement.

Alternatively, the processor 90 is further configured to perform at least one of RSRP measurement, RSRQ measurement, positioning measurement, tracking measurement and CSI measurement using the reference signal for measurement.

Alternatively, the processor 90 is further configured to determine sequences of a particular reference signal for measurement pre-configured for the UE through the configuration signaling as the dedicated sequences.

Alternatively, the transceiver 91 is further configured to determine that: the synchronization signal is transmitted on the carrier or cell which uses the predetermined spectrum resource and using a subframe and a frequency domain resource defined in LTE releases 8-11 for a FDD or TDD system; or the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling; or the subframe or OFDM symbol for transmitting the synchronization signal on the carrier or cell which uses the predetermined spectrum resource is determined in accordance with a pre-defined position of the subframe or OFDM symbol and an offset value for transmitting the synchronization signal on the carrier or cell which uses the predetermined spectrum resource. The offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling.

Alternatively, the synchronization signal includes a PSS and/or an SSS.

Alternatively, the transceiver 91 is further configured to notify a bandwidth of the carrier or cell which uses the predetermined spectrum resource to the UE in advance through signaling; or notify the bandwidth of the carrier or cell which uses the predetermined spectrum resource to a master base station in advance, so that the master base station notifies the bandwidth to the UE in advance through signaling, or in the case that the bandwidth of the carrier or cell which uses the predetermined spectrum resource is not notified by the base station or the master base station to the UE in advance through the configuration signaling, determine that the UE receives the reference signal for measurement and perform the measurement on a pre-defined bandwidth in the middle of the carrier or cell which uses the predetermined spectrum resource, and the pre-defined bandwidth is of a value not less than 6 RBs, or a value not less than a minimum bandwidth defined in an LTE system.

Alternatively, the transceiver 91 is further configured to determine the predetermined spectrum resource as an unlicensed spectrum resource, and/or determine a secondary carrier or secondary cell pre-configured for the UE through the configuration signaling as the serving carrier or serving cell.

In FIG. 9, a bus architecture may include a number of buses and bridges connected to each other, so as to connect various circuits for one or more processors 90 and one or more memories. In addition, as is known in the art, the bus architecture may be used to connect any other circuits, such as a circuit for a peripheral device, a circuit for a voltage stabilizer and a power management circuit. Bus interfaces are provided, and the transceiver 91 may consist of more than one elements, e.g., a transmitter and a receiver for communication with any other devices over a transmission medium. The processor 90 takes charge of managing the bus architecture as well as general processings. The memory may store therein data desired for the operation of the processor 90.

According to the embodiments of the present disclosure, the UE may identify the cell and determine whether or not the signal is currently received from the serving cell, and in the case that the signal is currently received from the serving cell, perform the measurement and/or the data transmission. As a result, it is able to prevent the UE from receiving the erroneous data or performing the measurement and/or the data transmission based on the erroneous signal, thereby to prevent the system performance from being degraded and to utilize the predetermined spectrum resource appropriately. For example, in the case that the signal transmission method in the embodiments of the present disclosure is applied to an unlicensed spectrum resource, it is able to provide an effective, feasible scheme about how an LTE system operates at the unlicensed spectrum resource, thereby to prevent the mutual interferences among the systems due to the resource preemption, improve the measurement performance and the data transmission performance of the LTE system over the unlicensed spectrum resource, and improve the system performance.

The basic principle of the present disclosure has been described hereinbefore in conjunction with the embodiments. However, it should be appreciated that, after reading the descriptions of the present disclosure, it is able for a person skilled in the art, using a basic programming skill, to implement any or all steps of the method and any or all members of the device in any computing device (including a processor and a storage medium) or a network consisting of the computing devices, in the form of hardware, firmware, software or a combination thereof.

Hence, the purposes of the present disclosure may also be implemented by one program or a set of programs running on any computing device, e.g., a known general-purpose computer, or implemented merely by a program product including programs codes capable of implementing the method or device. In other words, this program product and a storage medium storing therein the program product also constitute a part of the present disclosure. Obviously, the storage medium may be any known storage medium or a storage medium that may occur in future.

The present disclosure further provides in some embodiments a storage medium (e.g., a Read Only Memory (ROM), a Random Access Memory (RAM), a hard disk, or a removable memory). The computer program for the signal transmission may be stored in the storage medium, and include program codes so as to receive the signal on the carrier or cell which uses the predetermined spectrum resource, determine whether or not the received signal belongs to a serving carrier or cell of the UE, and in the case that the received signal belongs to the serving carrier or cell of the UE, perform the measurement and/or data transmission in accordance with the received signal and/or the subsequently-received signal.

The present disclosure further provides in some embodiments a storage medium (e.g., a Read Only Memory (ROM), a Random Access Memory (RAM), a hard disk, or a removable memory). The computer program for the signal transmission may be stored in the storage medium, and include program codes so as to transmit the signal on the carrier or cell which uses the predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by a UE, whether or not a signal received by the UE on the carrier or cell which uses the predetermined spectrum resource belongs to a serving carrier or serving cell of the UE or at least includes the judge signal and a data signal, the judge signal is further used for measurement.

The present disclosure further provides in some embodiments a computer program, which include program codes so as to receive the signal on the carrier or cell which uses the predetermined spectrum resource, determine whether or not the received signal belongs to a serving carrier or cell of the UE, and in the case that the received signal belongs to the serving carrier or cell of the UE, perform the measurement and/or data transmission in accordance with the received signal and/or the subsequently-received signal.

The present disclosure further provides in some embodiments a computer program, which include program codes so as to transmit the signal on the carrier or cell which uses the predetermined spectrum resource. The signal at least includes a judge signal for determining, by a UE, whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by a UE, whether or not a signal received by the UE on the carrier or cell which uses the predetermined spectrum resource belongs to a serving carrier or serving cell of the UE or at least includes the judge signal and a data signal, the judge signal is further used for measurement.

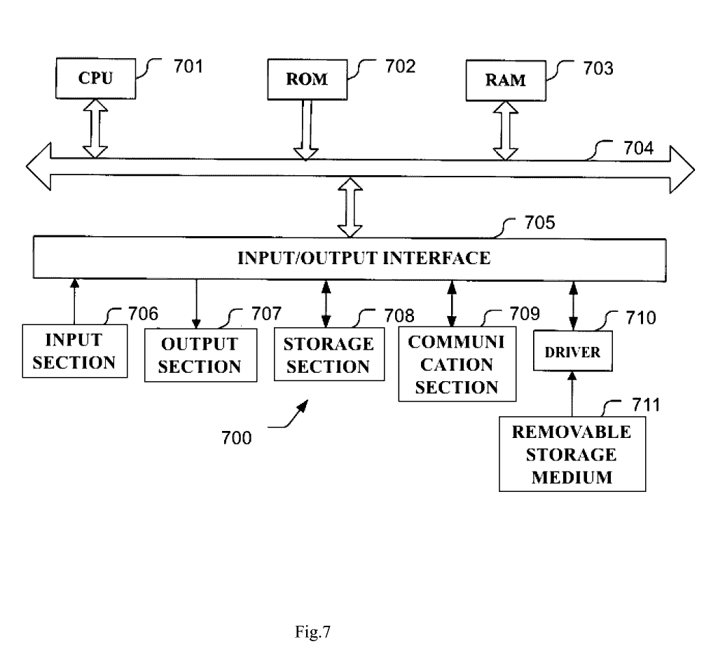

In the case that the present disclosure is implemented in the form of software and/or firmware, programs may be installed in a computer with a dedicated hardware structure, e.g., a general-purpose computer 700 in FIG. 7, via the storage medium or a network, so as to achieve various functions.

In FIG. 7, a Central Processing Unit (CPU) 701 may execute various processings in accordance with the programs stored in a ROM 702 or the programs loaded into a RAM 703 via a storage section 708. Data desired for the operation of the CPU 701 may also be stored in the RAM 703 according to the practical need. The CPU 701, the ROM 702 and the RAM 703 are connected to each other via a bus 704. In addition, an input/output interface 705 is also connected to the bus 704.

An input section 706 (including a keyboard and a mouse), an output section 707 (including a display such as Cathode Ray Tube (CRT) or a Liquid Crystal Display (LCD), and a speaker), a storage section 708 (including a hard disk) and a communication section 709 (including a network interface card such as Local Area Network (LAN) card, and a Modem) may also be connected to the input/output interface 705. The communication section 709 is configured to perform the communication over a network, e.g., Internet.

If desired, a driver 710 may also be connected to the input/output interface 705, and a removable storage medium 711 such as a magnetic disk, an optical disk, a magneto-optical disk or a semiconductor memory may be installed on the driver 710, so as to read the computer programs therefrom and install them into the storage section 708.

In the case that the above-mentioned processings are implemented via software, the programs may be installed from the network, e.g., Internet, or the storage medium, e.g., the removable storage medium 711.

It should be appreciated that, the storage medium is not limited to the removable storage medium 711 in FIG. 7 in which the programs are stored and which may be distributed in such a manner as to be detachable from the device so as to provide the programs to a user. The removable storage medium 711 may include a magnetic disk (including a floppy disk (registered trademark), an optical disk (including Compact Disk Read Only Memory (CD-ROM) and Digital Video Disk (DVD), a magneto-optical disk (including Mini Disk (registered trademark)) and a semiconductor memory. Alternatively, the storage media may be a hard disk included in the storage section 708 and the ROM 702 in which the programs are stored, and the storage media may be distributed to the user together with the device including them.

It should be further appreciated that, according to the device and the method in the embodiments of the present disclosure, the members and/or steps may be subdivided and/or recombined, which shall also be deemed as equivalents of the present disclosure. In addition, the steps for executing the above-mentioned processings may be performed in a chronological order. Of course, some steps may also be performed in parallel, or independently of each other.

It should be appreciated that, the present disclosure may be provided as a method, a system or a computer program product, so the present disclosure may be in the form of full hardware embodiments, full software embodiments, or combinations thereof. In addition, the present disclosure may be in the form of a computer program product implemented on one or more computer-readable storage mediums (including but not limited to disk memory, CD-ROM and optical memory) including computer-readable program codes.

The present disclosure is described with reference to the flow charts and/or block diagrams showing the method, device (system) and computer program product according to the embodiments of the present disclosure. It should be appreciated that each process and/or block, or combinations thereof, in the flow charts and/or block diagrams may be implemented via computer program commands. These computer program commands may be applied to a general-purpose computer, a special-purpose computer, an embedded processor or any other processor of programmable data processing equipment, so as to form a machine, thereby to obtain the means capable of effecting the functions specified in one or more processes in the flow charts and/or one or more blocks in the block diagrams in accordance with the commands executed by the computer or the processor of the other programmable data processing equipment.

These computer program commands may also be stored in a computer-readable memory capable of guiding the computer or the other programmable data processing equipment to work in a special manner, so as to form a product including a command device capable of effecting the functions specified in one or more processes in the flow charts and/or one or more blocks in the block diagrams.

These computer program commands may also be loaded onto a computer or the other programmable data processing equipment, so as to perform a series of operations thereon and generate the processings implemented by the computer, thereby to provide the steps capable of effecting the functions specified one or more processes in the flow charts and/or one or more blocks in the block diagrams in accordance with the instructions.

Although the preferred embodiments are described above, a person skilled in the art may make modifications and alterations to these embodiments in accordance with the basic concept of the present disclosure. So, the attached claims are intended to include the preferred embodiments and all of the modifications and alterations that fall within the scope of the present disclosure.

What is claimed is:

1. A signal transmission method, comprising steps of:
receiving, by a User Equipment (UE), a signal on a carrier or cell which uses a predetermined spectrum resource, and determining whether or not the received signal belongs to a serving carrier or serving cell of the UE; and
in the case that the received signal belongs to the serving carrier or serving cell of the UE, performing measurement and/or data transmission by the UE in accordance with the received signal and/or a subsequently-received signal.

2. The signal transmission method according to claim 1, wherein the step of performing the measurement and/or data transmission by the UE in accordance with the received signal and/or the subsequently-received signal comprises at least one of:
performing the measurement by the UE in accordance with a received reference signal for measurement;
receiving by the UE a further reference signal for measurement, and performing the measurement in accordance with the received further reference signal for measurement;
performing the data transmission by the UE in accordance with received scheduling signaling;
receiving by the UE further scheduling signaling, and performing the data transmission in accordance with the received further scheduling signaling.

3. The signal transmission method according to claim 2, wherein the reference signal for measurement is transmitted on an Orthogonal Frequency Division Multiplexing (OFDM) symbol on which synchronization signals are currently transmitted and using all frequency domain resources other than the frequency domain resources occupied by the synchronization signals, or
the reference signal for measurement is transmitted on an OFDM symbol on which synchronization signals are currently transmitted and using parts of the frequency domain resources other than the frequency domain resources occupied by the synchronization signals, or
the reference signal for measurement is transmitted on an OFDM symbol adjacent to, or separated by a fixed time domain interval from, the OFDM symbol on which synchronization signals are currently transmitted, and the reference signal for measurement and at least one synchronization signal in the synchronization signals are transmitted within an identical subframe, or
the reference signal for measurement is the synchronization signal, and/or,
wherein sequences of the reference signal for measurement are generated at least in association with an Identifier (ID) of a carrier or cell on which the reference signal is currently transmitted, or
in the case that the reference signal for measurement is used for measuring Reference Signal Received Power (RSRP) and/or Channel State Information (CSI), sequences of the reference signal for measurement are generated at least in association with an ID of a carrier or cell on which the reference signal is currently transmitted, or
sequences of the reference signal for measurement are sequences of a UE-specific or cell-specific measurement reference signal and pre-configured by configuration signaling, or
in the case that the reference signal for measurement is used for measuring CSI, sequences of the reference signal for measurement is sequences of a UE-specific or cell-specific measurement reference signal and pre-configured through configuration signaling, and/or,
wherein the reference signal for measurement is used for at least one of RSRP measurement, Reference Signal Received Quality (RSRQ) measurement, positioning measurement, tracking measurement and CSI measurement.

4-5. (canceled)

6. The signal transmission method according to claim 1, wherein the step of determining by the UE whether or not the received signal belongs to the serving carrier or serving cell comprises at least one of:
detecting, by the UE, a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell;
detecting, by the UE, dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

7. The signal transmission method according to claim 6, wherein the step of detecting, by the UE, the synchronization signal corresponding to the ID of the carrier or cell in accordance with the ID of the carrier or cell pre-configured through the configuration signaling comprises:
detecting, by the UE, the synchronization signal corresponding to the ID of the carrier or cell in each subframe or a predetermined subframe in which the synchronization signal is to be transmitted in accordance with the ID of the carrier or cell pre-configured through the configuration signaling; and/or
the step of detecting, by the UE, the dedicated sequences pre-configured through the configuration signaling comprises:
detecting, by the UE, the dedicated sequences in each subframe or a predetermined subframe, the predetermined subframe being a particular subframe pre-configured through the configuration signaling, or a subframe determined in accordance with a detection period, or the detection period and a subframe offset value, pre-configured through the configuration signaling, and/or,
wherein the dedicated sequences are sequences of a particular reference signal for measurement pre-configured for the UE through the configuration signaling, and/or
the UE detects the dedicated sequences in an energy detection manner.

8. (canceled)

9. The signal transmission method according to claim 3, wherein
the synchronization signal is transmitted on the carrier or cell which uses the predetermined spectrum resource and using a subframe and a frequency domain resource defined in Long-Term Evolution (LTE) Releases 8-11 for a Frequency Division Duplex (FDD) or Time Division Duplex (TDD) system; or
the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or
a subframe or OFDM symbol for transmitting the synchronization signal on the carrier or cell which uses the predetermined spectrum resource is acquired in advance in accordance with the configuration signaling; or
an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol for transmitting the synchronization signal and the offset value; and/or
the synchronization signal comprises a Primary Synchronization Signal (PSS) and/or a Secondary Synchronization Signal (SSS).

10. The signal transmission method according to claim 1, wherein
a bandwidth of the carrier or cell which uses the predetermined spectrum resource is notified in advance through the configuration signaling, or
in the case that the bandwidth of the carrier or cell which uses the predetermined spectrum resource is unknown, the UE receives the reference signal for measurement and performs the measurement on a pre-defined bandwidth in the middle of the carrier or cell which uses the predetermined spectrum resource, and the pre-defined bandwidth is of a value not less than 6 Resource Blocks (RBs), or a value not less than a minimum bandwidth defined in an LTE system; and/or
the predetermined spectrum resource is an unlicensed spectrum resource; and/or
the serving carrier or serving cell is a secondary carrier or secondary cell pre-configured for the UE through the configuration signaling; and/or
the carrier or cell which uses the predetermined spectrum resource is a secondary carrier or secondary cell pre-configured for the UE through the configuration signaling.

11. A signal transmission method, comprising a step of:
transmitting, by a base station, a signal on a carrier or cell which uses a predetermined spectrum resource, wherein the signal at least comprises a judge signal for determining, by a User Equipment (UE), whether or not a signal received by the UE on the carrier or cell which uses the predetermined spectrum resource belongs to a serving carrier or serving cell of the UE and further comprises a reference signal for measurement and/or a data signal, or the signal at least comprises a judge signal for determining, by the UE, whether or not a signal received by the UE on the carrier or cell which uses the predetermined spectrum resource belongs to a serving carrier or serving cell of the UE or at least includes the judge signal and a data signal, and the judge signal is further used for measurement.

12. The signal transmission method according to claim 11, further comprising:
determining, by the base station, whether or not a current channel resource on the carrier or cell which uses the predetermined spectrum resource is free;
in the case that the current channel resource is free, transmitting, by the base station, the signal on the carrier or cell which uses the predetermined spectrum resource; and
in the case that the current channel resource is busy, prohibiting, by the base station, the transmission of the signal on the carrier or cell which uses the predetermined spectrum resource, or transmitting, by the base station, the signal on the carrier or cell which uses the predetermined spectrum resource after a predetermined time period, wherein the predetermined time period has a length of a pre-defined fixed value, or the length of the predetermined time period is notified to the UE in advance through signaling, and/or
wherein the judge signal is a synchronization signal corresponding to an Identifier (ID) of the carrier or cell which uses the predetermined spectrum resource, and the base station transmits the synchronization signal and the reference signal for measurement and/or the data signal, or transmits the synchronization signal, or transmits the synchronization signal and the data signal, on the carrier or cell which uses the predetermined spectrum resource, wherein the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling; or the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling; or the base station transmits the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling; and/or
the judge signal is dedicated sequences corresponding to the carrier or cell which uses the predetermined spectrum resources or dedicated sequences of the UE, and the base station transmits the dedicated sequences and a reference signal for measurement and/or a data signal, or transmits the dedicated sequences, or transmits the dedicated sequences and the data signal, on the carrier or cell which uses the predetermined spectrum resources, wherein the base station transmits the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling; or the base station transmits the dedicated sequences in each subframe or a pre-defined subframe on the carrier or cell which uses the predetermined spectrum resource, the dedicated sequences are pre-configured for the UE through the configuration signaling, and the pre-defined subframe is a particular subframe pre-configured through the configuration signaling or a subframe determined in accordance with a detection period, or the detection period and a subframe offset value, pre-configured through the configuration signaling; or the base station transmits the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

13. (canceled)

14. The signal transmission method according to claim 11, wherein
the reference signal for measurement is transmitted on an Orthogonal Frequency Division Multiplexing (OFDM) symbol on which synchronization signals are currently transmitted and using all frequency domain resources other than the frequency domain resources occupied by the synchronization signals, or the reference signal for measurement is transmitted on an OFDM symbol on which synchronization signals are currently transmitted and using parts of the frequency domain resources other than the frequency domain resources occupied by the synchronization signals, or the reference signal for measurement is transmitted on an OFDM symbol adjacent to, or separated by a fixed time domain interval from, the OFDM symbol on which synchronization signals are currently transmitted and the reference signal for measurement and at least one synchronization signal in the synchronization signals are transmitted within an identical subframe, or the reference signal for measurement is the synchronization signal; and/or
sequences of the reference signal for measurement are generated at least in association with an ID of a carrier or cell on which the reference signal is currently transmitted, or in the case that the reference signal for measurement is used for measuring Reference Signal Received Power (RSRP) and/or Channel State Information (CSI), sequences of the reference signal for measurement are generated at least in association with the ID of a carrier or cell on which the reference signal is currently transmitted, or sequences of the reference signal for measurement are sequences of a UE-specific or cell-specific measurement reference signal and pre-configured by configuration signaling, or in the case that the reference signal for measurement is used for measuring CSI, sequences of the reference signal for measurement is sequences of a UE-specific measurement reference signal and pre-configured through configuration signaling; and/or
the reference signal for measurement is used for at least one of RSRP measurement, Reference Signal Received Quality (RSRQ) measurement, positioning measurement, tracking measurement and CSI measurement; and/or
the dedicated sequences are sequences of a particular reference signal for measurement pre-configured for the UE through the configuration signaling, and/or
wherein the synchronization signal is transmitted on the carrier or cell which uses the predetermined spectrum resource and using a subframe and a frequency domain resource defined in Long-Term Evolution (LTE) releases 8-11 for a Frequency Division Duplex (FDD) or Time Division Duplex (TDD) system; or
the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or
the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling; or
the subframe or OFDM symbol for transmitting the synchronization signal is determined in accordance with a pre-defined position of the subframe or OFDM symbol and an offset value for transmitting the synchronization signal on the carrier or cell which uses the predetermined spectrum resource, the offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling; and/or
the synchronization signal comprises a Primary Synchronization Signal (PSS) and/or a Secondary Synchronization Signal (SSS).

15. (canceled)

16. The signal transmission method according to claim 11, wherein a bandwidth of the carrier or cell which uses the predetermined spectrum resource is notified by the base station to the UE in advance through signaling; or the bandwidth of the carrier or cell which uses the predetermined spectrum resource is notified by the base station to a master base station in advance, and notified by the master base station to the UE in advance through signaling; or the bandwidth of the carrier or cell which uses the predetermined spectrum resource is notified by the master base station to the UE in advance through configuration signaling; or in the case that the bandwidth of the carrier or cell which uses the predetermined spectrum resource is not notified by the base station or the master base station to the UE in advance through the configuration signaling, the base station determines that the UE receives the reference signal for measurement and perform the measurement on a pre-defined bandwidth in the middle of the carrier or cell which uses the predetermined spectrum resource, wherein the pre-defined bandwidth is of a value not less than 6 Resource Blocks (RBs), or a value not less than a minimum bandwidth defined in an LTE system; and/or
the predetermined spectrum resource is an unlicensed spectrum resource; and/or
the carrier or cell is a secondary carrier or secondary cell pre-configured for the UE through the configuration signaling.

17. A signal transmission apparatus, comprising a transceiver, a processor and a memory, wherein
the transceiver is configured to receive and transmit a signal under the control of the processor; and
the processor is configured to read a program stored in the memory so as to, in the case that the transceiver receives the signal on a carrier or cell which uses a predetermined spectrum resource, determine whether or not the received signal belongs to a serving carrier or serving cell of a User Equipment (UE), wherein
the transceiver is further configured to, in the case that the received signal belongs to the serving carrier or serving cell of the UE, perform measurement and/or data transmission in accordance with the received signal and/or a subsequently-received signal.

18. The signal transmission apparatus according to claim 17, wherein the transceiver is further configured to perform at least one of the following processings:
performing the measurement by the UE in accordance with a received reference signal for measurement;
receiving a further reference signal for measurement, and performing the measurement in accordance with the received further reference signal for measurement;
performing the data transmission in accordance with received scheduling signaling; and
receiving further scheduling signaling, and performing the data transmission in accordance with the received further scheduling signaling, and/or
wherein the processor is further configured to perform at least one of the following processings:
detecting a synchronization signal corresponding to the ID of the carrier or cell in accordance with the ID of the carrier or cell pre-configured through the configuration signaling, and in response to the synchronization signal corresponding to the ID of the carrier or cell being detected, determining that the received signal belongs to the serving carrier or serving cell; and
detecting dedicated sequences corresponding to the serving carrier or serving cell of the UE or dedicated sequences for the UE pre-configured through the configuration signaling, and in response to the dedicated sequences being detected, determining that the received signal belongs to the serving carrier or serving cell.

19. The signal transmission apparatus according to claim 18, wherein the transceiver is further configured to:
receive the reference signal for measurement on an Orthogonal Frequency Division Multiplexing (OFDM) symbol on which synchronization signals are currently transmitted and using all frequency domain resources other than the frequency domain resources occupied by the synchronization signals, or receive the reference signal for measurement on an OFDM symbol on which synchronization signals are currently transmitted and using parts of the frequency domain resources other than the frequency domain resources occupied by the synchronization signals, or receive the reference signal for measurement on an OFDM symbol adjacent to, or separated by a fixed time domain interval from, the OFDM symbol on which synchronization signals are currently transmitted, wherein the reference signal for measurement and at least one synchronization signal in the synchronization signals are transmitted within an identical subframe, or receive the synchronization signal as the reference signal for measurement; and/or
the transceiver is further configured to generate sequences of the reference signal for measurement at least in association with an Identifier (ID) of a carrier or cell on which the reference signal is currently transmitted, or in the case that the reference signal for measurement is used for measuring Reference Signal Received Power (RSRP) and/or Channel State Information (CSI), generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific or cell-specific measurement reference signal and pre-configured through configuration signaling as sequences of the reference signal for measurement; and/or
the transceiver is further configured to perform at least one of RSRP measurement, Reference Signal Received Quality (RSRQ) measurement, positioning measurement, tracking measurement and CSI measurement using the reference signal for measurement.

20. (canceled)

21. The signal transmission apparatus according to claim 17, wherein in the case that the processor detects the synchronization signal corresponding to the ID of the carrier or cell in accordance with the ID of the carrier or cell pre-configured through the configuration signaling, the processor is further configured to detect the synchronization signal corresponding to the ID of the carrier or cell in each subframe or a predetermined subframe in which the synchronization signal is to be transmitted in accordance with the ID of the carrier or cell pre-configured through the configuration signaling; and/or
in the case that the processor detects the dedicated sequences pre-configured through the configuration signaling, the processor is further configured to detect the dedicated sequences in each subframe or a predetermined subframe, and the predetermined subframe is a particular subframe pre-configured through the configuration signaling, or a subframe determined in accordance with a detection period, or the detection period and a subframe offset value, pre-configured through the configuration signaling, and/or,
wherein the processor is further configured to determine sequences of a particular reference signal for measurement pre-configured for the UE through the configuration signaling as the dedicated sequences, and/or detect the dedicated sequences in an energy detection manner.

22. (canceled)

23. The signal transmission apparatus according to claim 19, wherein
the synchronization signal is transmitted on the carrier or cell which uses the predetermined spectrum resource and using a subframe and a frequency domain resource defined in Long-Term Evolution (LTE) Releases 8-11 for a Frequency Division Duplex (FDD) or Time Division Duplex (TDD) system; or
the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or
a subframe or OFDM symbol for transmitting the synchronization signal on the carrier or cell which uses the predetermined spectrum resource is acquired in advance in accordance with the configuration signaling; or
an offset value for transmitting the synchronization signal on the carrier or cell which uses the predetermined spectrum resource is acquired in advance in accordance with the configuration signaling, and the UE determines a subframe or OFDM symbol for transmitting the synchronization signal on the carrier or cell which uses the predetermined spectrum resource in accordance with a pre-defined position of the subframe or OFDM symbol and the offset value; and/or
the synchronization signal comprises a Primary Synchronization Signal (PSS) and/or a Secondary Synchronization Signal (SSS).

24. The signal transmission apparatus according to claim 17, wherein the transceiver is further configured to determine that a bandwidth of the carrier or cell which uses the predetermined spectrum resource is notified in advance through the configuration signaling, or in the case that the bandwidth of the carrier or cell which uses the predetermined spectrum resource is unknown, receive the reference signal for measurement and perform the measurement on a pre-defined bandwidth in the middle of the carrier or cell which uses the predetermined spectrum resource, and the pre-defined bandwidth is of a value not less than 6 Resource Blocks (RBs), or a value not less than a minimum bandwidth defined in an LTE system; and/or
the transceiver or the processor is further configured to determine that the predetermined spectrum resource is an unlicensed spectrum resource; and/or
the transceiver is further configured to determine that the carrier or cell is a secondary carrier or secondary cell pre-configured for the UE through the configuration signaling; and/or
the transceiver is further configured to determine that the carrier or cell which uses the predetermined spectrum resource is a secondary carrier or secondary cell pre-configured for the UE through the configuration signaling.

25. A signal transmission apparatus for a base station, comprising a processor, a transceiver and a memory, wherein
the processor is configured to read a program stored in the memory and generate a signal; and
the transceiver configured to, under the control of the processor, receive and transmit the signal on a carrier or cell which uses a predetermined spectrum resource,
wherein the signal at least comprises a judge signal for determining, by a User Equipment (UE), whether or not a signal received by the UE on the carrier or cell which uses the predetermined spectrum resource belongs to a serving carrier or serving cell of the UE and further includes a reference signal for measurement and/or a data signal, or the signal at least includes a judge signal for determining, by the UE, whether or not a signal received by the UE on the carrier or cell which uses the predetermined spectrum resource belongs to a serving carrier or serving cell of the UE or at least includes the judge signal and a data signal, and the judge signal is further used for measurement.

26. The signal transmission apparatus according to claim 25, wherein
the processor is further configured to determine whether or not a current channel resource on the carrier or cell which uses the predetermined spectrum resource is free,
wherein in the case that the current channel resource is free, the transceiver is further configured to transmit the signal on the carrier or cell which uses the predetermined spectrum resource, and in the case that the current channel resource is busy, the transceiver is further configured to prohibit the transmission of the signal on the carrier or cell which uses the predetermined spectrum resource, or transmit the signal on the carrier or cell which uses the predetermined spectrum resource after a predetermined time period, wherein the predetermined time period has a length of a pre-defined fixed value, or the length of the predetermined time period is notified to the UE in advance through signaling, and/or
in the case that the judge signal is a synchronization signal corresponding to an Identifier (ID) of the carrier or cell which uses the predetermined spectrum resource, the transceiver is configured to transmit the synchronization signal and the reference signal for measurement and/or the data signal, or transmit the synchronization signal, or transmit the synchronization signal and the data signal, on the carrier or cell which uses the predetermined spectrum resource, wherein the transceiver is configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by a master base station for the UE through configuration signaling; or the transceiver is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is pre-configured by the base station for the UE through configuration signaling; or the transceiver is further configured to transmit the synchronization signal in each subframe, or in a predetermined subframe in which the synchronization signal is to be transmitted, on the carrier or cell which uses the predetermined spectrum resource, and the ID of the carrier or cell which uses the predetermined spectrum resource is notified by the base station to a master base station in advance and pre-configured by the master base station for the UE through the configuration signaling; and/or
in the case that the judge signal is dedicated sequences corresponding to the carrier or cell which uses the predetermined spectrum resources or dedicated sequences of the UE, the transceiver is configured to transmit the dedicated sequences and a reference signal for measurement and/or a data signal, or transmit the dedicated sequences, or transmit the dedicated sequences and the data signal, on the carrier or cell which uses the predetermined spectrum resources, wherein the transceiver is further configured to transmit the dedicated sequences in each subframe or a pre-defined subframe on the carrier or cell which uses the predetermined spectrum resource, the dedicated sequences are pre-configured by a master base station for the UE through configuration signaling, and the pre-defined subframe is a particular subframe pre-configured through the configuration signaling or a subframe determined in accordance with a detection period, or the detection period and a subframe offset value, pre-configured through the configuration signaling; or the transceiver is further configured to transmit the dedicated sequences in each subframe or a pre-defined subframe on the carrier or cell which uses the predetermined spectrum resource, the dedicated sequences are pre-configured by the base station for the UE through the configuration signaling, and the pre-defined subframe is a particular subframe pre-configured through the configuration signaling or a subframe determined in accordance with a detection period, or the detection period and a subframe offset value, pre-configured through the configuration signaling; or the transceiver is further configured to transmit the dedicated sequences in each subframe or a pre-defined subframe on the carrier or cell which uses the predetermined spectrum resource, the dedicated sequences are notified by the base station to a master base station in advance and pre-configured by the master base station for the UE through the configuration signaling, and the pre-defined subframe is a particular subframe pre-configured through the configuration signaling or a subframe determined in accordance with a detection period, or the detection period and a subframe offset value, pre-configured through the configuration signaling.

27. (canceled)

28. The signal transmission apparatus according to claim 27, wherein the transceiver is further configured to transmit the reference signal for measurement on an Orthogonal Frequency Division Multiplexing (OFDM) symbol on which synchronization signals are currently transmitted and using all frequency domain resources other than the frequency domain resources occupied by the synchronization signals, or transmit the reference signal for measurement on an OFDM symbol on which synchronization signals are currently transmitted and using parts of the frequency domain resources other than the frequency domain resources occupied by the synchronization signals, or transmit the reference signal for measurement on an OFDM symbol adjacent to, or separated by a fixed time domain interval from, the OFDM symbol on which synchronization signals are currently transmitted wherein the reference signal for measurement and at least one synchronization signal in the synchronization signals are transmitted within an identical subframe, or transmit the synchronization signal as the reference signal for measurement; and/or
the processor is further configured to generate sequences of the reference signal for measurement at least in association with an ID of a carrier or cell on which the reference signal is currently transmitted, or in the case that the reference signal for measurement is used for measuring Reference Signal Received Power (RSRP) and/or Channel State Information (CSI), generate sequences of the reference signal for measurement at least in association with an ID of a carrier or cell on which the reference signal is currently transmitted, or determine sequences of a UE-specific or cell-specific measurement reference signal and pre-configured by configuration signaling as sequences of the reference signal for measurement, or in the case that the reference signal for measurement is used for measuring CSI, determine sequences of a UE-specific measurement reference signal and pre-configured through configuration signaling as sequences of the reference signal for measurement; and/or
the processor is further configured to perform at least one of RSRP measurement, Reference Signal Received Quality (RSRQ) measurement, positioning measurement, tracking measurement and CSI measurement using the reference signal for measurement; and/or
the processor is further configured to determine sequences of a particular reference signal for measurement pre-configured for the UE through the configuration signaling as the dedicated sequences, and/or
wherein the transceiver is further configured to determine that:
the synchronization signal is transmitted on the carrier or cell which uses the predetermined spectrum resource and using a subframe and a frequency domain resource defined in Long-Term Evolution (LTE) Releases 8-11 for a Frequency Division Duplex (FDD) or Time Division Duplex (TDD) system; or
the synchronization signal is mapped to and transmitted over a first OFDM symbol or the preceding two OFDM symbols in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, without other reference signal, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region, in a subframe pre-defined to transmit the synchronization signal on the carrier or cell which uses the predetermined spectrum resource, or in a first available subframe on the carrier or cell which uses the predetermined spectrum resource; or
the synchronization signal is mapped to and transmitted over a first OFDM symbol or the preceding two OFDM symbols, other than a control region and without other reference signal, in a subframe for transmitting the synchronization signal on the carrier or cell which uses the predetermined spectrum resource, or in a first available subframe on the carrier or cell which uses the predetermined spectrum resource; or
the subframe or OFDM symbol for transmitting the synchronization signal on the carrier or cell which uses the predetermined spectrum resource is acquired by the base station from a master base station in advance or pre-defined, and notified by the master base station to the UE in advance through the configuration signaling, or the subframe or OFDM symbol for transmitting the synchronization signal on the carrier or cell which uses the predetermined spectrum resource is predetermined by the base station and notified by the base station to a master base station in advance, and notified to the UE by the master base station in advance through the configuration signaling, or the subframe or OFDM symbol for transmitting the synchronization signal on the carrier or cell which uses the predetermined spectrum resource is predetermined by the base station and notified by the base station to the UE in advance through the configuration signaling; or
the subframe or OFDM symbol for transmitting the synchronization signal on the carrier or cell which uses the predetermined spectrum resource is determined in accordance with a pre-defined position of the subframe or OFDM symbol and an offset value for transmitting the synchronization signal on the carrier or cell which uses the predetermined spectrum resource, wherein the offset value is acquired by the base station from a mater base station or pre-defined, and notified by the master base station to the UE in advance through the configuration signaling, or the offset value is predetermined by the base station and notified to a master base station in advance, and notified by the master base station to the UE in advance through the configuration signaling, or the offset value is predetermined by the base station and notified by the base station to the UE in advance through the configuration signaling; and/or
the synchronization signal comprises a Primary Synchronization Signal (PSS) and/or a Secondary Synchronization Signal (SSS).

29. (canceled)

30. The signal transmission apparatus according to claim 25, wherein the transceiver is further configured to:
notify a bandwidth of the carrier or cell which uses the predetermined spectrum resource to the UE in advance through signaling; or notify the bandwidth of the carrier or cell which uses the predetermined spectrum resource to a master base station in advance, so that the master base station notifies the bandwidth to the UE in advance through signaling; or in the case that the bandwidth of the carrier or cell which uses the predetermined spectrum resource is not notified by the base station or the master base station to the UE in advance through the configuration signaling, determine that the UE receives the reference signal for measurement and perform the measurement on a pre-defined bandwidth in the middle of the carrier or cell which uses the predetermined spectrum resource, wherein the pre-defined bandwidth is of a value not less than 6 Resource Blocks (RBs), or a value not less than a minimum bandwidth defined in an LTE system; and/or
the transceiver is further configured to determine the predetermined spectrum resource as an unlicensed spectrum resource, and/or determine a secondary carrier or secondary cell pre-configured for the UE through the configuration signaling as the serving carrier or serving cell.
